(19) United States
(12) Patent Application Publication
(10) Pub. No.: US 2015/0213389 A1
(43) Pub. Date: Jul. 30, 2015

(54) DETERMINING AND ANALYZING KEY PERFORMANCE INDICATORS

(71) Applicant: Adobe Systems Incorporated, San Jose, CA (US)

(72) Inventor: Kourosh Modarresi, Los Altos, CA (US)

(73) Assignee: Adobe Systems Incorporated, San Jose, CA (US)

(21) Appl. No.: 14/167,984

(22) Filed: Jan. 29, 2014

(51) Int. Cl. G06Q 10/06

(52) U.S. Cl. CPC G06Q 10/06393

(57) ABSTRACT

Methods and systems for determining Key Performance Indicators (KPIs) associated with electronic content, such as website content. A method receives a request to determine a significance of an input variable to an output variable, wherein the input variable is a website characteristic and the output variable is a website-interaction metric. The method retrieves a data set comprising information about website characteristics of existing websites and historical information about actual interactions with the existing websites, wherein the data set comprises entries for the input variable and entries for the output variable for one or more websites. The method then replaces missing entries with implied values and determines the significance of the input variable to the output variable.

### TECHNICAL FIELD

This disclosure relates generally to computer-implemented methods and systems for determining and analyzing Key Performance Indicators (KPIs) for electronic content and more particularly relates to determining KPIs for analytics data associated with online content.

### BACKGROUND

In order to operate a commercial website successfully, it is desirable to measure and track the ways visitors interact with the website, so that metrics such as usability, effectiveness and conversion rate of the website can be analyzed. Such analytics data can be used in order to take informed actions that change the website's content, appearance, structure, design and functionality to support the website operator's business goals. Various computing applications allow companies and other entities to analyze performance of marketing campaigns and advertising, analyze revenue trends, and/or perform other business functions. Companies and other organizations use metrics and inputs from multiple sources, such as analytics vendors, advertising agencies, search vendors, display vendors, email vendors, stores, inventory, financial logs, etc. In these contexts, it may be desirable to determine key performance indicators (KPIs). Metrics and other website analytics data related to electronic content accessed at computing devices can be collected via communications networks such as the Internet.

KPIs can help companies and other entities measure progress towards important organizational goals. In the context of web analytics, KPIs can enable organizations to measure the performance of online initiatives, such as websites, online marketing campaigns, online channels, web applications (web apps), etc. against critical business objectives. For example, KPIs can include metrics used to determine the health or success of a website. If an organization's goal for their website is to get visitors to make purchases, then that organization's KPIs may include revenue, orders, and units. Alternatively, if the goal of the organization's website is to generate leads, such as sales leads and referrals, then the organization may monitor a ‘leads generated’ KPI.

Current solutions for identifying KPIs do not evaluate the significance of each input variable to any specific metric as output. Existing solutions can result in mis-identifying unclear, vague, or non-actionable metrics as KPIs. Current web analytics tools do not measure the dependence of a metric (i.e., an output) on any given specific input variable (i.e., a predictor). As a result, existing solutions do not provide analytics tools that allow users to choose any variable as a metric (i.e., an output of the tool) and any number of variables as input (predictors).

### SUMMARY

One embodiment involves analyzing one or more Key Performance Indicators (KPIs) associated with electronic content. The embodiment receives a request to determine a significance of an input variable to an output variable, wherein the input variable is a website characteristic and the output variable is a website-interaction metric. The embodiment involves retrieving a data set comprising information about website characteristics of existing websites and historical information about actual interactions with the existing websites, wherein the data set comprises values for the input variable and values for the output variable for one or more websites. The embodiment further involves replacing missing entries in the data set with implied values and determining the significance of the input variable to the output variable.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram depicting components of a system for determining Key Performance Indicators (KPIs), in accordance with embodiments;

FIG. 2 is a flow chart illustrating an example method for determining KPIs, in accordance with embodiments;

FIGS. 3A-3C depict exemplary data matrices, in accordance with embodiments;

FIG. 4 depicts a matrix of partial customer purchasing data for websites;

FIG. 5 depicts a matrix of completed customer purchasing data for websites, in accordance with embodiments;

FIG. 6 illustrates decision trees, in accordance with embodiments;

FIG. 7 depicts an example random forest of decision trees, in accordance with embodiments;

FIG. 8 illustrates an example random forest of decision trees with weighted averages, in accordance with embodiments;

FIG. 9 depicts variable significance for a set of websites, in accordance with embodiments;

FIG. 10 illustrates an example plotted output of variable significance, in accordance with embodiments;

FIGS. 11 and 12 illustrate exemplary outputs showing partial dependence of outputs on specified variables, in accordance with embodiments; and

FIG. 13 is a diagram of an exemplary computer system in which embodiments of the present disclosure can be implemented.

### DETAILED DESCRIPTION

Methods and systems are disclosed for determining key performance indicators (KPIs) by evaluating metrics. The methods and systems determine feature significance and identify dependencies for one or more specified metrics to allow selection of one or more metrics as KPIs. Potential KPIs can be compared to identify the potential KPIs that are relatively more dependent upon certain input variables. The metrics that are most dependent upon those certain input variables can be recommended or selected as the KPIs used in evaluating the performance of a website. For example, in the online advertising context, this can involve evaluating the significance and dependencies of input variables involving advertising and website characteristics with respect to resulting web site purchases and other online user behavior metrics. Those metrics—the potential KPIs—relating to those resulting purchases and other online user behaviors can be compared to select or recommend KPIs that are most sensitive to particular input variables. As a specific example, a user may wish to identify KPIs that are the most dependent upon an “advertisement frequency” input variable and learn that a “visits” metric reflecting number of visits to the website would be a better KPI than a “revenue per visit” metric based on a determination that the “visits” metric is more dependent upon advertisement frequency and, correspondingly, that the “revenue per visit” metric is relatively less dependent upon the advertisement frequency input variable. More generally, relative significance of a specified metric as compared to a set of input variables can be determined by evaluating the significance of one or more input variables to the specified metric. Embodiments measure the dependence of a metric on any given specific input variable (predictor). A chosen metric's significance and dependency on the other variables is determined and can be used, for example, by a publisher of a website in order to take actions regarding online advertising campaigns and monetization of online content within short time intervals.

Exemplary methods and systems disclosed herein allow publishers of online content to take appropriate actions regarding a desired monetization approach for their online content based on KPIs. The methods and systems determine KPIs by evaluating the significance of each input variable in a set of variables to any specified metric. The dependence of a metric (i.e., an output) on any given specific input variable (i.e., a predictor) is measured. In an embodiment, for given website analytics data, a method enables a user to choose any variable as a metric (output) to be evaluated and any number of variables as inputs (predictors). In this embodiment, the predictor and input variable are identical, and the output and metric are identical. That is, the selected metric is an output that is evaluated using a set of input variables that function as predictors.

One embodiment uses the following steps to determine KPIs.

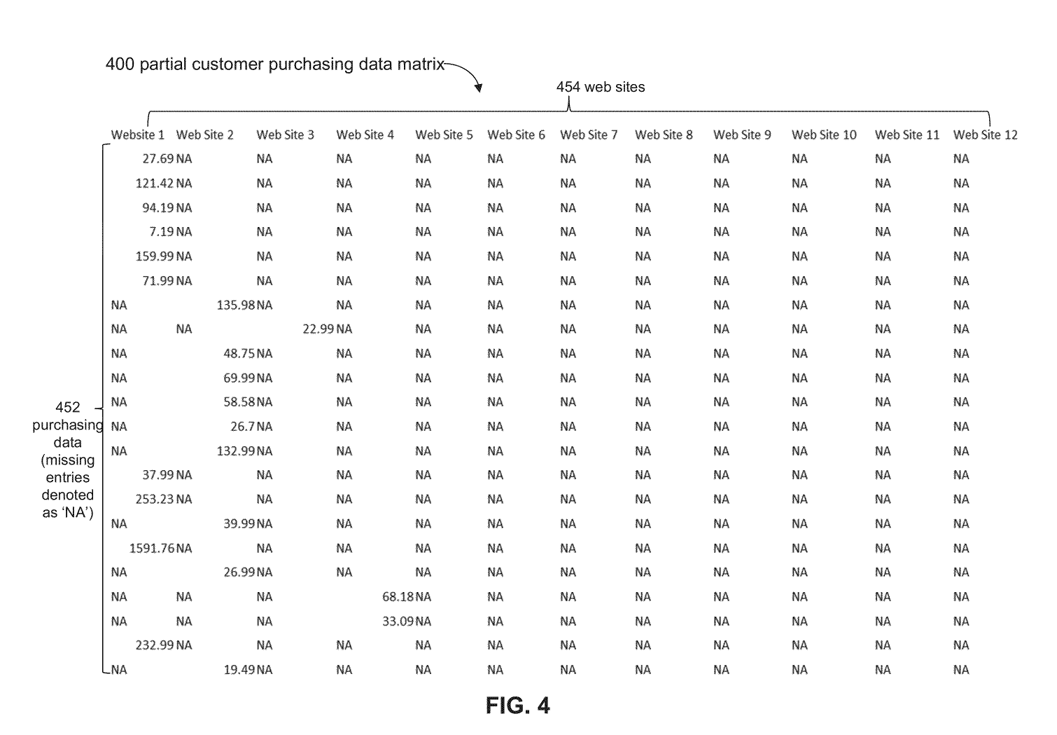

First, a data set related to electronic content, such as, for example, website content, is retrieved. Missing entries in the data set are replaced with implied values. As an example, in cases where a user or website visitor has only seen a few advertisements (i.e., ads), conversion data for the user will only be available for these few ads. However, there may be many more ads (i.e., thousands of ads) that the user has not seen. In such cases, for a data set of values related to the user, only entries in the data set related to the ads seen by the user will have data, and the rest of the entries will not have data. An example of this is shown in FIG. 4 where a data set of values is embodied as a matrix, and rows of the matrix without data are denoted as ‘NA’. Embodiments replace these missing NA entries with implied (i.e., computed) values. In the example of a matrix of conversion data, replacing missing matrix entries with implied values enables ads with high conversion metrics to be identified and sent to a user. This may be done by determining the similarity of ads to other ads (ads-to-ads) and users to other users (i.e., users-to-users). In order to be able to determine the similarity of ads-to-ads and users-to-users, missing entries in a matrix are replaced. Certain embodiments use Singular Value Decomposition (SVD) to replace missing entries in a matrix by projecting the data to much lower dimensional space, thus removing the noise and creating a fully-populated matrix. In one embodiment, missing entries in a matrix of data values are replaced with computed values using an iterative version of SVD on the matrix. By replacing missing entries with implied values, highly dimensional, but sparsely populated data sets with high correlation can be used.

By using SVD, embodiments exploit the data set properties (i.e., high dimension, sparsely populated data matrices) to determine that most of the dimensions in the data set are just noise. For example, SVD with a sparseness constraint or a regularized SVD (RSVD) can find the most relevant dimensions by removing the noise. This transferring of data to a lower dimensional space allows reconstruction of the data set using only a small (implicit) number of dimensions. The reconstructed data set (i.e., a reconstructed matrix) has values for all entries. Embodiments handle cases where it is difficult to know the exact dimensional space that the data must be projected to, by iteratively performing an SVD or an RSVD of the matrix to compute the missing entries.

The next step involves using binary decision trees as base learners for classifying data values in the data set. This step uses a group of decision trees. In this way even a weak, individual algorithm (i.e., one decision tree) can be used to contribute to highly accurate decisions, given a large amount of data and a combination of multiple weak algorithms (i.e., a group of base/weak learners). Base learners can readily produce an individual decision. An embodiment uses Classification and Regression Trees (CART) decision trees as base learners. As an individual base learner can be inaccurate (i.e., produce an inaccurate decision), embodiments combine many base learners (i.e., many decision trees) and use a form of a majority vote, which results in very accurate overall decisions. In certain embodiments, this step uses Classification and Regression Trees (CART) decision trees.

The next step involves collectively using the decision trees in an ensemble method to classify the data values. An embodiment uses a random forest of decision trees for this step.

At this point, test data can be used to calculate the misfit error for each input each variable in a set of input variables. An embodiment divides data into two parts, training data and test data. According to this embodiment, the training data is used to formulate a model (i.e., an algorithm) and the accuracy of the algorithm is checked using the test data. In one embodiment, a mean squared error (MSE) is calculated and used as a measure of accuracy of the algorithm or model. For example, 1,000 data points can be divided into two parts, where a training data set of 750 points is used to train the algorithm and the remaining 250 data points make up the test data. The data points for training and test data can be embodied as rows in a matrix. In this example, to see how the algorithm works or determine how accurate the algorithm is, the trained algorithm is used on the test data set of 250 rows. The test data is not expected to fit the model exactly because the test data was not the data used for training The degree or amount of misfit is the misfit error. In embodiments where an MSE is calculated, a good, accurate algorithm will have a relatively small MSE. At this point, we have an original MSE and a second MSE, where the second MSE is a permuted MSE after permutation of a specific input variable. The MSE for the algorithm can be scaled/normalized. For example, the MSE can be scaled based on a normal distribution using the following equation: (original MSE-permuted MSE)/standard deviation (of all MSE differences).

In additional or alternative embodiments, a Gini index can be used to calculate misfit errors. According to these embodiments, the Gini index can be used as a metric indicating a measure of purity of the nodes of decision trees in the same way MSE is used. Regardless of whether MSE or a Gini index is used, the average misfit error for each variable in a set of input variables is normalized in order to determine the respective significance of each input variable to a selected output variable. The selected output variable can be, for example, a metric to be evaluated as a potential KPI for a website.

The techniques disclosed herein can be used on a variety of metrics and a variety of input variables in the website context and other contexts. Non-limiting examples of input variables for a website can include: a number of new visitors to the website that register, a number of new visitors that do not register, a number of return visitors that sign-in and have purchased, a number of advertisement impressions, an advertisement frequency, length of a website visit, starting time of a visit, ending time of a visit, average visit length, frequency of visits, time of a conversion or purchase on the website, visitor groups targeted by an advertising campaign, a number of return visitors that sign-in and have not purchased, a number of return visitors that do not sign-in and have purchased, and a number of return visitors that do not sign-in and have not purchased. For this exemplary set of input variables, exemplary metrics—potential KPIs—can include, but are not limited to, visits, revenue per visit (RPV), and a conversion rate of the website. KPIs can be identified for a website over a specified duration. For example, KPIs for a website can include revenue, a number of visits to the website, a number of inputs, such as clicks or selections, that visitors have on the website, or any arbitrary variable related to user interactions with the website over a specified duration. The duration can be an increment of time such as, for example, a number of minutes, hours, days, months, or portions thereof. The methods and systems disclosed herein enable users to determine, for example, the relative dependence of a web analytics metric on increases or decreases in input variables (i.e., predictors) for a website. This dependence on predictor input variables enables users to predict the impact on identified KPIs resulting from fluctuations in values of input variables. Exemplary methods populate a matrix of data values for input variables and evaluate the impact on KPIs as values in the matrix increase or decrease. In this way, the methods enable users to readily identify KPIs and then strategically modify the input variables to achieve desired performance results as will be reflected in the identified KPIs. In the above example in which a “visits” metric is determined to be a better KPI than a “revenue per visit” metric because the “visits” metric is more dependent upon the advertisement frequency, the user can vary the advertisement frequency, observe the changes in the visits metric and adjust advertisement to achieve desired objectives, for example, achieving an optimal visit to advertising cost ratio.

KPIs determined by the techniques disclosed herein can relate to conversions on a website.

As used herein, a “conversion” refers to the success of a specific variant or instance of a component in eliciting a response from a visitor to a website. For example, a web page component can be embodied as a selectable (i.e., clickable) offer or advertisement. In this example, a conversion refers to the success of that offer or advertisement in eliciting a response from a visitor to the website. When a website visitor clicks, selects, or otherwise interacts with the offer or advertisement, that interaction can be deemed a conversion. Components of a web page can be selected to navigate to a different web page. When such components are clicked on, the visitor can be presented with the different page, where the components and the different web page are specifically targeted to a segment or class of visitors that the visitor belongs to. This conversion of an offer to view a different page can be tracked and saved as analytics data and subsequently determined to be a KPI for the website. One non-limiting example of a conversion is an online purchase made by a website visitor. Conversion rates can vary for different versions of websites. For example, different versions or renditions of a website may be presented to visitors using different browsers and/or computing devices to navigate to the website.

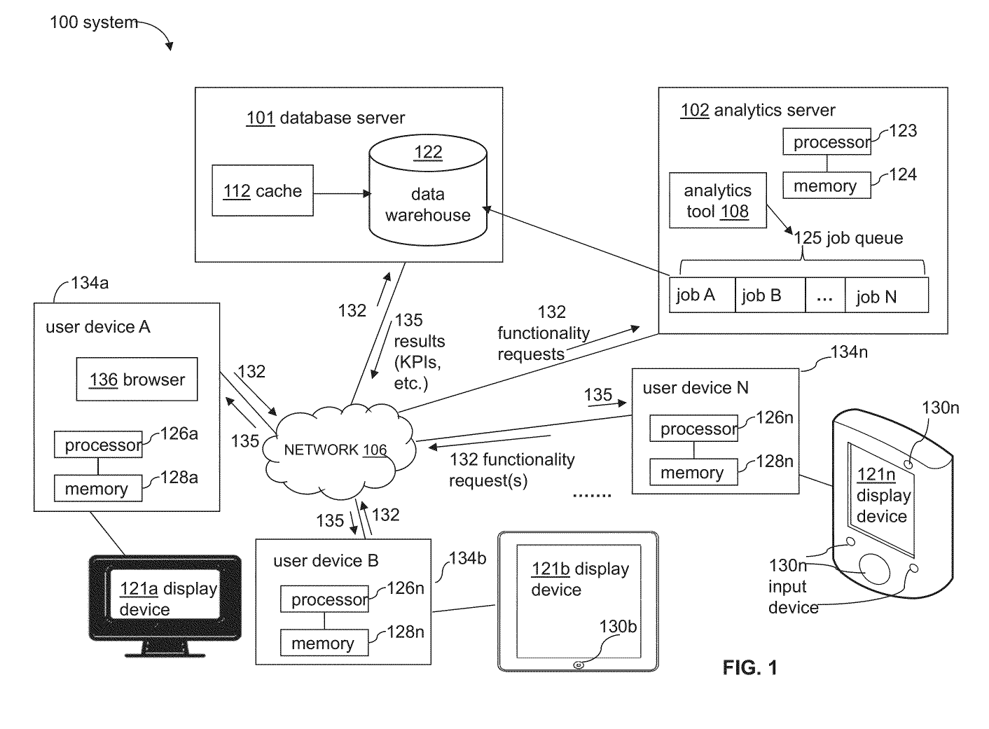

In the example embodiment of FIG. 1, a visitor can navigate to a website using a personal computer (PC) user device 134a executing a browser 136, another visitor can use a tablet user device 134b, and yet another visitor can navigate to the website using a smartphone user device 134n. Similarly, a set of users can use a variety of browsers to navigate to and interact with online content. Such browsers can include, but are not limited, to Microsoft Windows® Internet Explorer (IE), Firefox from the Mozilla Foundation, Chrome from Google Inc., Safari developed by Apple Inc., OPERA™ developed by Opera Software ASA, and Camino.

Embodiments disclosed herein determine KPIs by analyzing data sets with missing entries, high-dimensional data, quantitative (i.e., numerical) data, qualitative (i.e., categorical) data, and data sets including statistical outliers. The KPI determinations are made without removing missing entries or outliers from data sets. That is, the data sets are not cleaned up by removing missing entries or statistical outliers from data sets. Instead, an initial step of an exemplary method replaces missing entries with implied values. This step can be performed using an iterative version of Singular Value Decomposition (SVD). As will be appreciated by persons skilled in the relevant art(s), SVD is a factorization of a real or complex matrix, such as, for example, a high-dimensional matrix of data values. In embodiments, SVD is used to supply missing values in a data matrix by replacing missing entries with implied values. The following paragraphs describe how steps of the exemplary method are performed to use such a data set to determine KPIs.

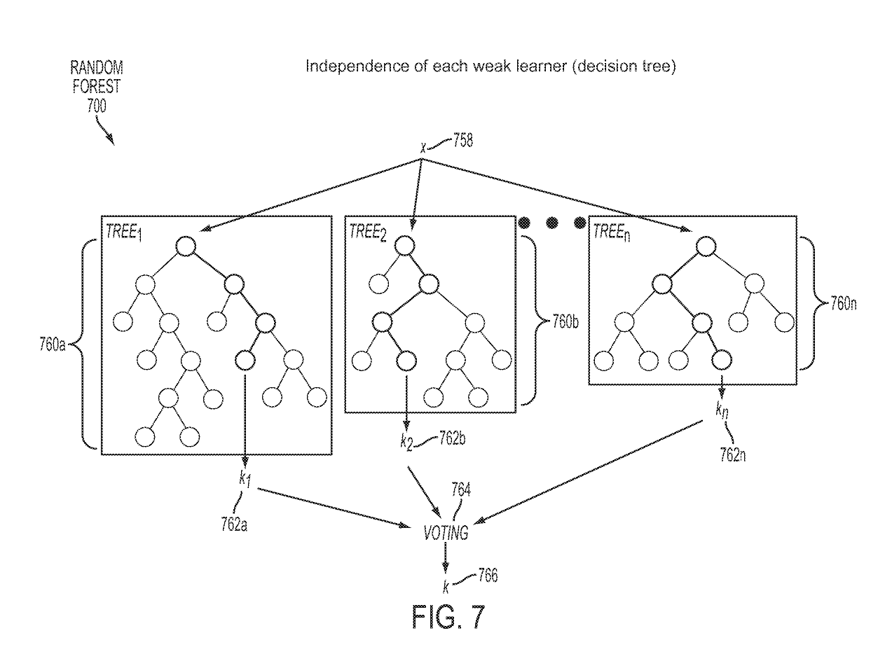

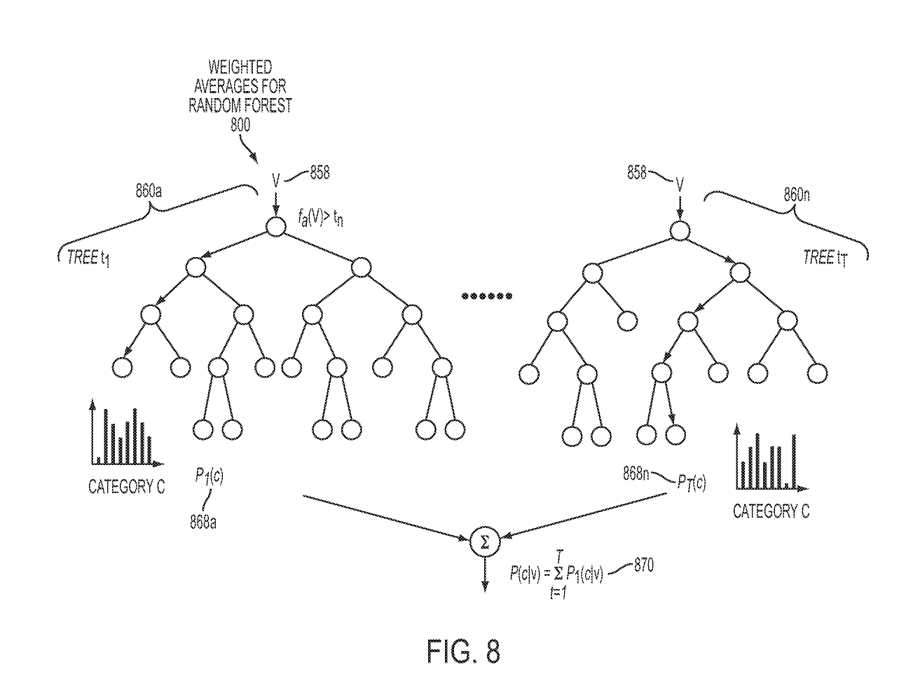

After the missing entries in the data set have been replaced with implied values, binary decision trees are used as base learners. In embodiments, decision tree learning comprises constructing a decision tree from class-labeled training tuples. As shown in FIGS. 7 and 8, a decision tree is a flow-chart-like structure, where each internal, non-leaf node denotes a test on an attribute, each branch represents the outcome of a test, and each leaf or terminal node holds a class label. Classification and Regression Trees (CART) can be used as base learners. For example, binary decision trees such as CART trees can be used for classification tree analysis in cases where the predicted outcome is the class to which data values belong. An embodiment uses a plurality of CART trees in an ensemble technique, such as, for example, a random forest of CART trees. As would be understood by those skilled in the relevant art(s), a random forest is a classifier that uses a number of decision trees in order to improve a classification rate. Random forests are an ensemble learning method or technique for classification and regression that operate by constructing a multitude of decision trees at training time and then outputting the class that is the mode of the classes output by individual decision trees. In certain embodiments, many CART trees are used in the random forest. For example, thousands, hundreds, or tens of thousands of decision trees (i.e., trees in the order of 10⁴) can be included in the random forest, with each decision tree acting independent of the others. Exemplary random forests of decision trees are provided in FIGS. 7 and 8.

At this point, a misfit error for each variable in a set of input variables is computed using test data. The respective misfit errors for variables can be computed using one or more of a Gini index and a mean squared error (MSE). The higher the MSE or Gini index values, the higher significance an input variable has. As would be understood by those skilled in the relevant art(s), the MSE of a predictor or estimator is a way to quantify the difference between data values implied by a predictor and true values of the quantity being estimated. The MSE is a risk function that corresponds to the expected value of the squared error loss or quadratic loss. The MSE measures the average of the squares of errors, such as the misfit errors, where an error is the amount by which a data value implied by the predictor differs from the quantity to be estimated. The difference occurs because of randomness or because the predictor does not account for information that could produce a more accurate estimate. The MSE is the second moment (about the origin) of the error, and thus incorporates both the variance of the predictor and the predictor's bias. For an unbiased predictor or estimator, the MSE is the variance of the predictor. The MSE can be used as an unbiased estimate of error variance.

As will be appreciated by persons skilled in the relevant art(s), the Gini index (alternatively, a Gini coefficient), is a measure of statistical dispersion. A low Gini index or coefficient value indicates a more equal distribution of values, with an index of zero corresponding to complete equality, whereas higher Gini coefficients indicate more unequal distribution of data values, with a Gini index of one corresponding to complete inequality. That is, a Gini coefficient of 1 (or 100%) indicates maximal inequality among data values. Conversely, a Gini coefficient of zero indicates perfect equality, where all data values are the same. In certain embodiments, the Gini coefficient is half of the relative mean difference, which is a mathematical equivalence, where the mean difference is the average absolute difference between two data values selected randomly from a data set, and the relative mean difference is the mean difference divided by the average, to normalize for scale.

Next, the average misfit for each variable is normalized. In embodiments, this normalization is performed with and without permutation. After normalization, significance of input variables is determined. The higher MSE or Gini index values, the higher significance an input variable has. KPIs are then determined based on the highly significant input variables.

Embodiments disclosed herein provide automated and semi-automated methods and systems for determining KPIs associated with user interactions with online content. The online content can include multimedia assets such as video content and advertisements (i.e., ads) included within the video content hosted on a website. In the context of online video content, exemplary methods and systems can determine a KPI for video advertisement views (i.e., ad views). Such a KPI can be analyzed to determine if ad views are down significantly because users watch video content on a website but fail to watch enough video to generate more ad views. Embodiments track outputs and metrics related to monetization, such as, but not limited to, presentations of and interactions with linear advertisements, overlay advertisements, and other types of advertisements in online content being viewed. Although exemplary computer-implemented methods and systems are described herein in the context of websites, it is to be understood that the systems and methods can be applied to multimedia assets, such as, but not limited to, web applications (web apps), interactive video on demand (VOD) assets (i.e., pay-per-view movies and rental assets), subscription video on demand (SVOD) assets, and software programs such as video games.

One embodiment provides a system that provides content publishers and businesses with KPIs related to monetization for their online content. This information can be provided to multiple teams or entities to enable them to take informed actions related to a given KPI in order to ensure that their online content, such as a website, is meeting their organizational goals. For example, the system can provide a network operation team or network administrator with information regarding input variables and predictors such as a current browser, computing device, or quality of service (QoS) for a network connection used to access and view electronic content and how that impacts identified KPIs. Also, for example, the system can provide a marketing team with optimal locations within online content to insert advertisements based on dependencies of output on specified variables related to the content and/or ads. The system can provide information to marketing staff regarding current revenue and budgets for online advertising campaigns in addition to monetization information.

Embodiments enable business stakeholders such as content publishers, network operation teams, marketing teams, business intelligence teams, and other entities to have current, accurate information regarding online experiences for electronic content of interest.

Exemplary embodiments identify KPIs based on specific, actionable, predictive metrics related to visitor engagement (i.e., viewer or audience engagement) for online content and monetization regarding ads included in the online content. By determining and analyzing KPIs, embodiments enable businesses and organizations to quickly identify effectiveness and profitability of online advertising strategies. For example, by identifying variable significance and dependence of output on specific variables related to visitor segment traffic and navigation, the systems and methods described herein enable organizations to identify KPIs. Exemplary embodiments produce output dependence and variable significance reports and render user interfaces that enable organizations to efficiently determine KPIs, identify input variable significance to specific metrics, and dependence of metrics on given input variables. The metrics can pertain to analytics data for online advertising. The user interfaces can include plots graphically depicting variable significance and output dependence across multiple versions of websites, browsers, or online assets. Embodiments identify KPIs based on metrics received from analytics systems such as, for example, Adobe® Analytics. These embodiments can provide customer requests for desired functionality to analytics tools such as, for example, Adobe® SiteCatalyst. Certain embodiments use real-time and historical analytics data and metrics data from a data warehouse and a cache (see, e.g., data warehouse 122 and cache 112 in FIG. 1).

As used herein, the term “metrics” is used to refer to data describing measures of performance for an organization or other entity. For example, business metrics can include data describing a number of sales, an amount of revenue, a number of orders, etc.

In an embodiment, the administrator user interface (UI) can be used to set and update parameters for determining KPIs. In certain embodiments, references to websites and other online content to be analyzed are provided via the administrator UI instead of full copies of the content. Metadata, metrics, and other data associated with the online content may be stored in a data warehouse. As used herein, the term “metadata” is used to refer to information associated with (and generally but not necessarily stored with) electronic content items such as video content and advertisements that provides information about a property of the electronic content item. Metadata may include information uniquely identifying an electronic content item. Such metadata may describe a storage location or other unique identification of the electronic content item. For example, metadata describing a storage location of online content may include a reference to a storage location of a copy of the online content in a server system used by publishers, advertisers, and users (i.e., website visitors). One example of such a reference is a Uniform Resource Locator (URL) identifying the storage location on a web server associated with a publisher's website. Such references can be provided by publishers as an alternative to uploading a copy of the online content to the system via the administrator UI.

An embodiment of the system includes a repository, such as a data warehouse or database, for storing items of electronic content (or references thereto), and their metadata. An example data warehouse 122 is described below with reference to FIG. 1. The metadata can include characteristics and properties of assets such as video content and advertisements for a website. Some properties, such as a genre or publisher, can apply to an entire asset, while other properties are relevant to certain portions such as pages of a website or frames of a video asset. Properties can identify compatible/supported rendering/viewing platform by indicating minimum requirements for viewing online content, such as supported resolutions, compatible browsers, video player applications, and supported user device platforms. For example, these properties can indicate a minimum display resolution, display size, operating system (OS) version, and/or player/browser version needed to render the online content. In embodiments, such properties can be stored separately from the online content in a repository such as data warehouse 122, which is described below with reference to FIG. 1.

As used herein, the term “video content” refers to any type of audiovisual media that can be displayed or played on computing devices via browsers, video player applications, game consoles, computer-implemented video playback devices, mobile multimedia devices, mobile gaming devices, and set top box (STB) devices. An STB can be deployed at a viewer's household to provide the user with the ability to control delivery of video content. Video content can be electronic content distributed to computing devices via communications networks such as, but not limited to, the Internet.

Online content including advertisements and offers can be selected and viewed by various browsers, video player applications, devices and platforms used to select and view online content. Such devices can be components of platforms including personal computers, smart phones, personal digital assistants (PDAs), tablet computers, laptops, digital video recorders (DVRs), remote-storage DVRs, interactive TV systems, and other systems capable of receiving and displaying online content and/or utilizing a network connection such as the Internet. An exemplary interactive TV system can include a television or other display device communicatively coupled to an STB. With reference to FIG. 1, exemplary user device 134a can include, without limitation, a display device 121a and a computing device configured to execute browser 136. The computing device can be embodied as any device including a processor 126a and a memory 128a. For example, the user device 134a can be embodied as a personal computer (PC), a laptop computer, or an Internet Protocol (IP)-based (i.e., IPTV) STB. As shown in FIG. 1, another exemplary user device 134b can be embodied as a tablet computing device, and yet another exemplary user device 134n can be embodied as a smartphone. References to a user device or user computing device should therefore be interpreted to include these devices and other similar systems involving display of electronic content via a browser 136 and viewer input.

Electronic content can be in the form of online content streamed from a server system to a web-enabled television (i.e., a smart television), a gaming system, or another user computing device. Streaming electronic content can include, for example, live and on-demand audiovisual content provided using a streaming protocol, such as, but not limited to, Internet Protocol television (IPTV), real-time messaging protocol (RTMP), hypertext transfer protocol (HTTP) dynamic streaming (HDS), HTTP Live Streaming (HLS), and Dynamic Adaptive Streaming over HTTP (MPEG-DASH). A web server or other server system can provide multiple renditions of websites and online content having different quality levels and language options, depending on the characteristics of the requesting browser 136 and/or the requesting user device 134.

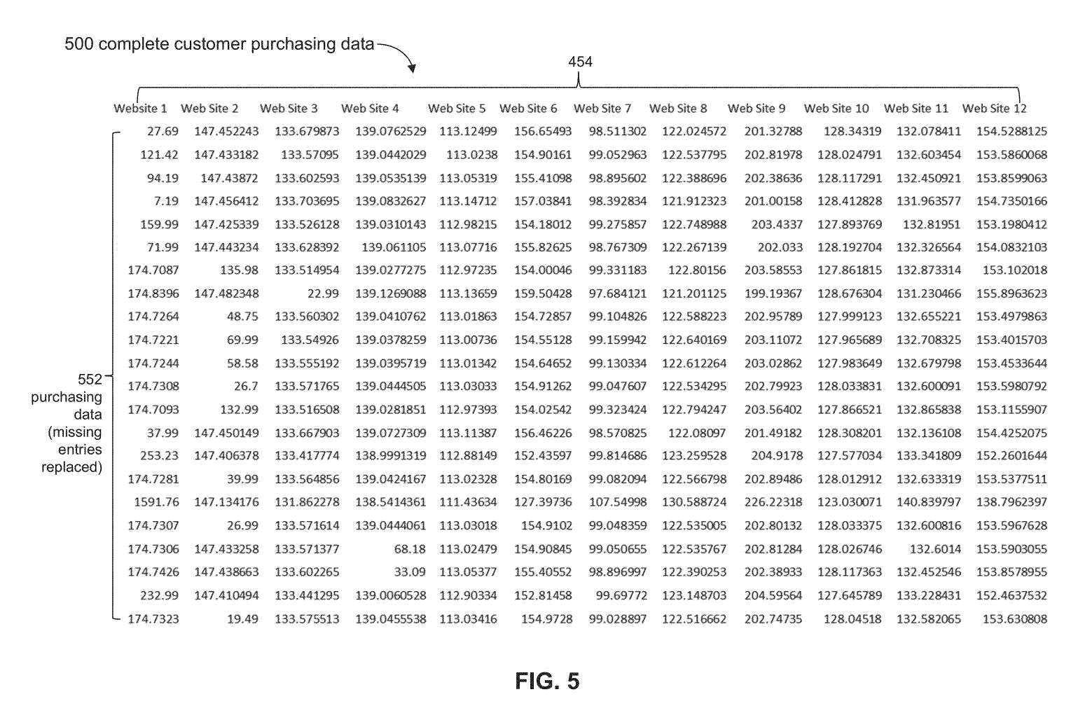

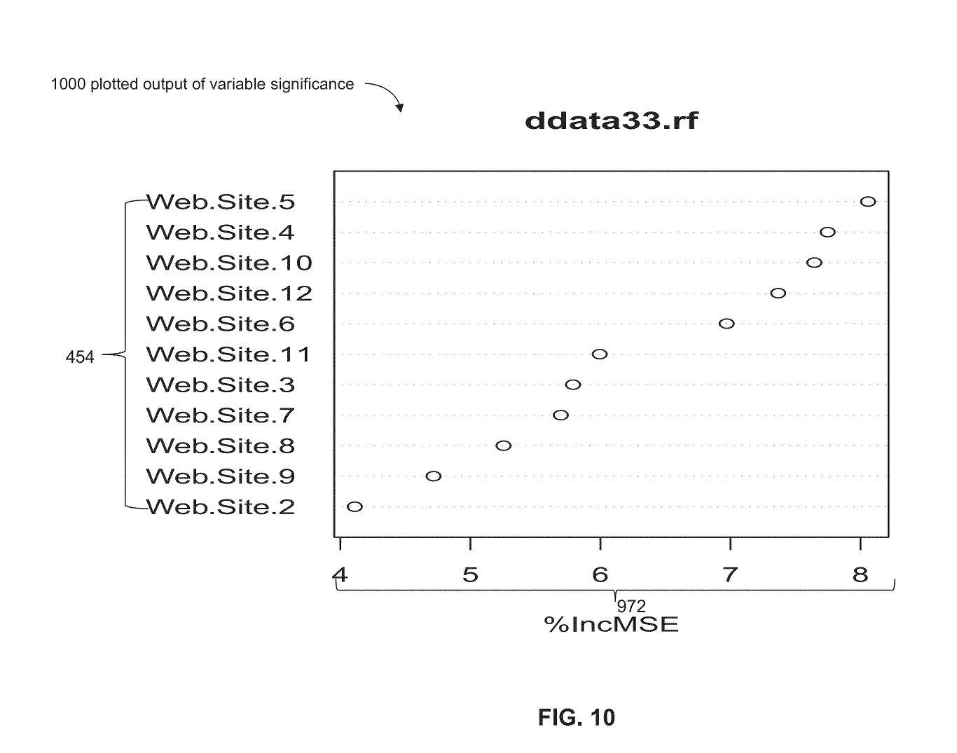

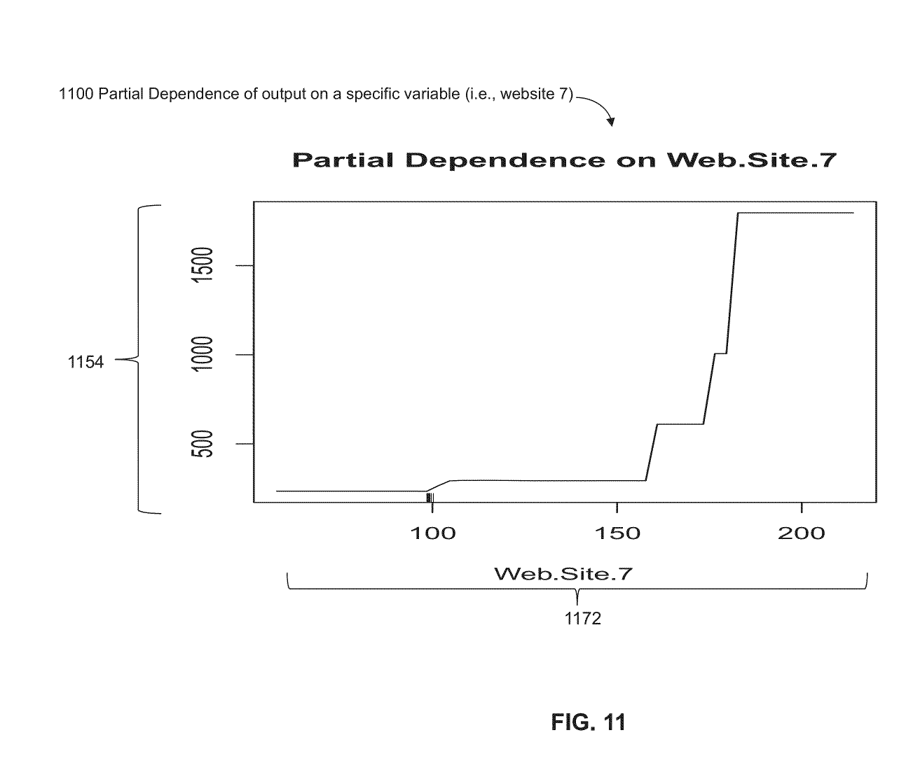

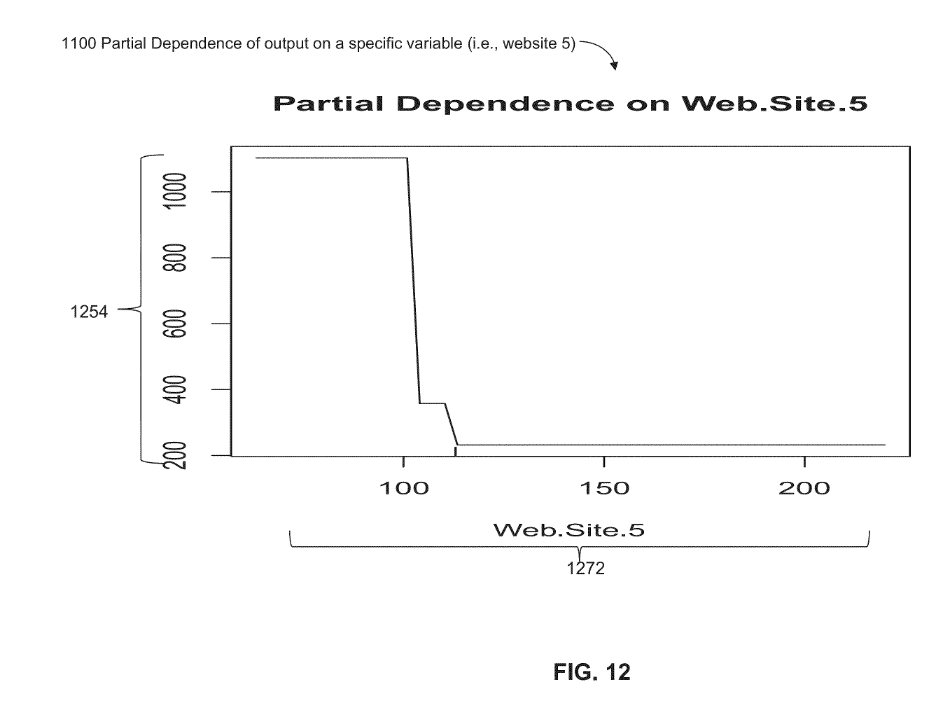

Computer-implemented systems and methods are disclosed for determining KPIs related to user interactions with online content and advertisements included within the online content. In embodiments, advertisements can include text, multimedia, or hypervideo content. An interactive user interface (UI) for an application executed at a computing device can be used to view reports displaying completed data sets (see, e.g., FIG. 5), plotting variable significance (see, e.g., FIG. 10), graphing partial dependencies of outputs on specified variables (see, e.g., FIGS. 11 and 12), and indicating identified KPIs. For example, in embodiments, real-time tracking and collection of events can be performed as the events occur without a perceivable delay after the occurrence of the events.

As used herein, the term “electronic content” is used to refer to any type of media that can be rendered for display, played on, or used at a computing device, television, or other electronic device. Computing devices include client and server devices such as, but not limited to, servers, desktop computers, laptop computers, smart phones, video game consoles, smart televisions, tablet computers, portable gaming devices, personal digital assistants, etc. Electronic content can include text or multimedia files, such as images, video, audio, or any combination thereof. Electronic content can be streamed to, downloaded by, and/or uploaded from computing devices. Electronic content can include multimedia hosted on websites, such as web television, Internet television, standard web pages, or mobile web pages specifically formatted for display on computing devices. Electronic content can also include application software developed for computing devices that is designed to perform one or more specific tasks at the computing device. Electronic content can be delivered as streaming video and as downloaded data in a variety of formats, such as, for example, a Moving Picture Experts Group (MPEG) format, an Audio Video Interleave (AVI) format, a QuickTime File Format (QTFF), a DVD format, an Advanced Authoring Format (AAF), a Material eXchange Format (MXF), and a Digital Picture Exchange (DPX) format. Electronic content can also include application software that is designed to perform one or more specific tasks at a computing system or computing device.

As used herein, the term “rendition” is used to refer to a copy of electronic content provided to a user device executing a browser or video player. Different renditions of electronic content can be encoded at different bit rates and/or bit sizes for use by user devices accessing electronic content over network connections with different bandwidths. Different renditions of the electronic content can include different advertisements for viewing on user devices located in different regions. Renditions of video content can vary according to known properties of a browser or video player application, a user device hosting the browser or video player application, and/or stream/network connectivity information associated with the user device. For example, a multimedia asset can include multiple renditions of a video as separate video clips, where each rendition has a different quality level associated with different bit rates.

As used herein, the term “asset” is used to refer to an item of electronic content included in a multimedia object, such as text, images, videos, or audio files. As used herein, the term “image asset” is used to refer to a digital image included in a multimedia object. One example of an image asset is an overlay advertisement. As used herein, the term “video asset” is used to refer to a video file included in a multimedia object. Video content can comprise one or more video assets. Examples of video assets include video content items such as online videos, television programs, movies, VOD videos, and SVOD videos and video games. Additional examples of video assets include video advertisements such as linear and hypervideo advertisements that can be inserted into video content items. As used herein, the term “text asset” is used to refer to text included in a multimedia object. Exemplary advertisements can be embodied as a text asset, an image asset, a video asset, or a combination of text, image, and/or video assets. For example, advertisements can include a text asset such as a name of a company, product, or service, combined with an image asset with a related icon or logo. Also, for example, advertisements can include video assets with animation or a video clip.

For simplicity, the terms “multimedia asset,” “video asset,” “online content,” and “video content” are used herein to refer to the respective electronic assets or online content regardless of their source, distribution means (i.e., website download, broadcast, or live streaming), format (i.e., MPEG, high definition, 2D, or 3D), or rendering means (i.e., browser 136 executing on a user device 134 or a video player application executing on a computing device) used to view such files and media. For example, renditions of a video asset can be embodied as streaming or downloadable online video content available from a website, and another rendition of the video asset can also be made available as video content on media such as a DVR recording or VOD obtained via an STB and viewed on a television.

As used herein, the term “network connection” refers to a communication channel of a data network. A communication channel can allow at least two computing systems to communicate data to one another. A communication channel can include an operating system of a first computing system using a first port or other software construct as a first endpoint and an operating system of a second computing system using a second port or other software construct as a second endpoint. Applications hosted on a computing system can access data addressed to the port. For example, the operating system of a first computing system can address packetized data to a specific port on a second computing system by including a port number identifying the destination port in the header of each data packet transmitted to the second computing system. When the second computing system receives the addressed data packets, the operating system of the second computing system can route the data packets to the port that is the endpoint for the socket connection. An application can access data packets addressed to the port.

### Exemplary System Implementation

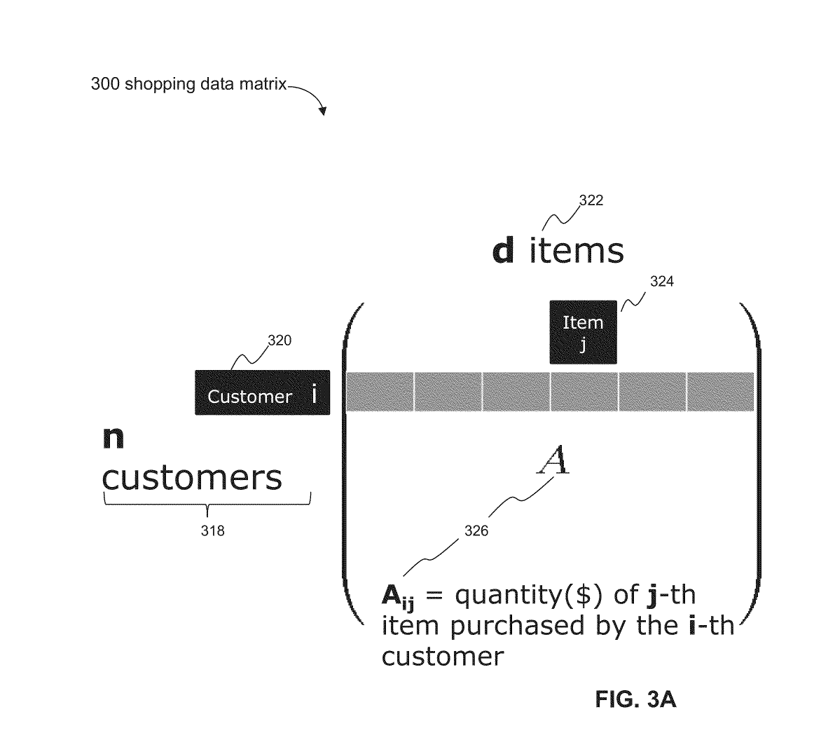

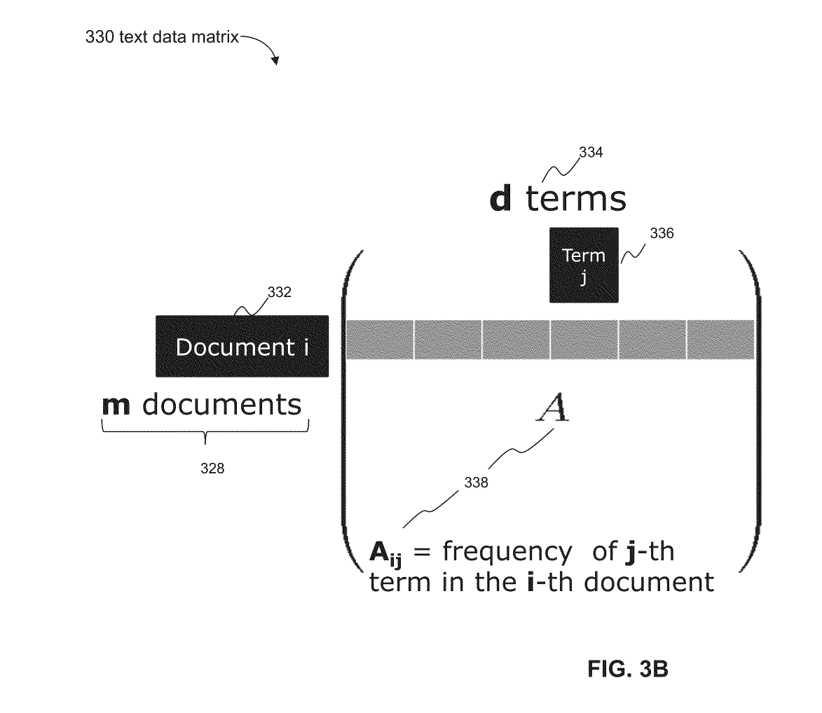

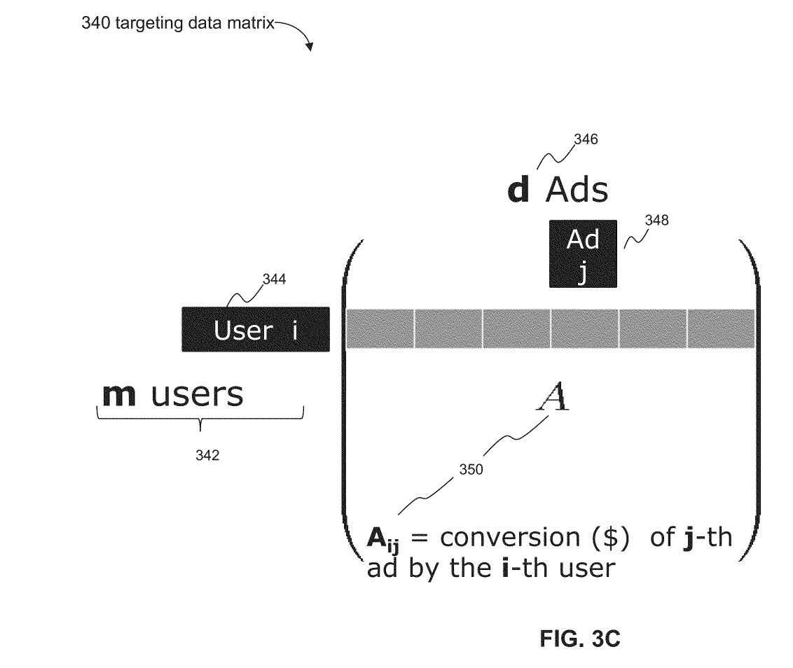

Referring now to the drawings, FIG. 1 is a block diagram illustrating components of an example system 100 implementing certain embodiments. The example system 100 can implemented as a digital marketing system or digital marketing suite. System 100 includes an analytics server 102 configured to perform server-side processing in response to inputs and data received from user devices 134 via a network 106. In accordance with embodiments, analytics server 102 is not a single physical server machine or platform, but is instead implemented using separate servers tied together through network, such as network 106. For example, analytics server 102 can be implemented as a cluster of servers, systems, and platforms. In the non-limiting example depicted in FIG. 1, analytics server 102 can host an analytics tool 108. As shown, system 100 includes a database server 101 that manages a data warehouse 122 storing metrics and data associated with online content, and hosts a cache 112. In the example of FIG. 1, both the database server 101 and the analytics server 102 are configured to receive functionality requests 132 from user devices 134 via network 106. Functionality requests 132 can be initiated by individual users via a request to identify one or more KPIs for a given set of data. A functionality request 132 can include a choice of one of a plurality of variables as output. For example, one output that can be selected for a functionality request 132 can be a user-specified website. The data set can include, for example, a matrix of data values related to online shopping (see, e.g., data matrix 300 of FIG. 3A), a matrix of text data (see, e.g., data matrix 330 of FIG. 3B), and a matrix of targeting data (see, e.g., data matrix 340 of FIG. 3C). As described below with reference to FIGS. 3A-3C, such matrices can have values for website customers, items for sale on websites, website users/visitors, advertisements, text documents, and terms appearing in text documents. For a given functionality requests 132, system 100 can show the requestor the impact of each of the inputs in a data set on the requestor's selected output. An exemplary plot showing the impact of inputs is provided in FIG. 10, which depicts a plot of variable significance. System 100 can also graphically depict partial independence of a requestor's selected output variable on any specific input variable. Exemplary graphs showing dependence of an output on specific variables are provided in FIGS. 11 and 12.

In one embodiment, analytics server 102 receives functionality requests 132 and puts jobs related to the received functionality requests 132 in a job queue 125. According to this embodiment, a functionality request 132 can be initiated via a user interface (UI) rendered by analytics tool 108. Such a UI can be rendered on a display device 121 of a requestor's user device 134. In alternative embodiments, functionality requests 132 can be sent directly to the database server 101 hosting data warehouse 122. The analytics tool 108 can be part of a dedicated analytics server, such as the analytics server 102 shown in FIG. 1, or another system or platform (not shown), such as, for example, Adobe® Analytics. In one non-limiting embodiment, analytics tool 108 can be embodied as the Adobe® SiteCatalyst tool. System 100 can provide businesses and advertisers with means for identifying and analyzing KPIs based on input metrics integrated from use of online content across multiple browsers 136 and user devices 134. For example, system 100 can be implemented as a digital marketing system or suite.

System 100 provides a platform for determining KPIs for online marketing initiatives provided to a plurality of user devices 134. Analytics server 102 can place entries into job queue 125 based on functionality requests 132 received from user devices 134. Embodiments of the servers, tools, queues and components shown in FIG. 1 can be configured to identify and analyze KPIs for any type of online content, including video assets such as, for example, online video, live video, streaming video, and advertisements and offers inserted into such online content. The advertisements can include any electronic content that can be inserted into online content, such as, but not limited to, pop-under advertisements, pop-up advertisements, banner advertisements, overlay advertisements, button advertisements, hyperlink advertisements, and hypervideo advertisements.

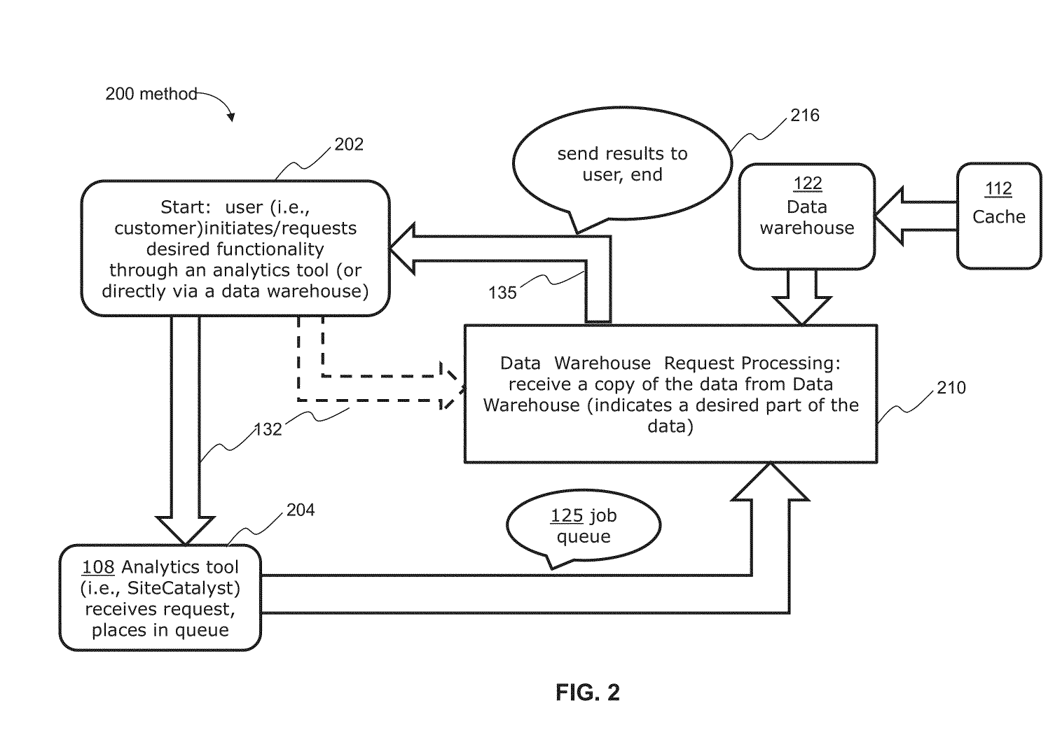

As shown in FIG. 1, user devices 134 can each include a processor 126 communicatively coupled to a memory 128. As shown, system 100 includes database server 101, analytics server 102, user devices 134a-n, and a network 106. User devices 134a-n are coupled to analytics server 102 via network 106. In additional or alternative embodiments, user devices 134a-n are also coupled to database server 101 via network 106. Processors 126a-n are each configured to execute computer-executable program instructions and/or accesses information stored in respective ones of memories 128a-n. Analytics server 102 includes a processor 123 communicatively coupled to a memory 124. Processor 123 is configured to execute computer-executable program instructions and/or accesses information stored in memory 124. Processors 123 and 126a-n shown in FIG. 1 may comprise a microprocessor, an application-specific integrated circuit (ASIC), a state machine, or other processor. For example, processor 123 can include any number of computer processing devices, including one. Processor 123 can include or may be in communication with a computer-readable medium. The computer-readable medium stores instructions that, if executed by the processor, cause one or more of processors 123 and 126a-n to perform the operations, functions, and steps described herein. When executed by processor 123 of analytics server 102 or processors 126a-n of user devices 134a-n, the instructions can also cause one or more of processors 123 and 126a-n to implement the tools, queues, and browsers shown in FIGS. 1 and 2. When executed by one or more of processors 126a-n of user devices 134a-n, the instructions can also cause processor to render the reports shown in FIGS. 4, 5 and 10-12 on respective ones of display devices 121a-n.

User devices 134a-n may also comprise a number of external or internal devices, including input devices 130 such as a mouse, keyboard, buttons, stylus, touch sensitive interface. User devices 134a-n can also comprise an optical drive such as a CD-ROM or DVD drive, a display device, audio speakers, one or more microphones, or any other input or output devices. For example, FIG. 1 depicts the user device 134a having a processor 126a, a memory 128a, and a display device 121a. A display device 121 can include (but is not limited to) a screen integrated with a user device 134, such as a liquid crystal display (“LCD”) screen, a touch screen, or an external display device 121, such as a monitor.

For simplicity, an exemplary browser 136 is shown in FIG. 1 as being hosted on user device 134a. It is to be understood that in embodiments, each of the user devices 134a-n include respective browsers 136 or other applications, such as, for example a video player application.

As shown, user devices 134a-n each include respective display devices 121a-n. User devices 134 can render online content and assets, such as websites, video content, and associated advertisements and offers in the browser 136 shown in FIG. 1. User devices 134 can also render the reports shown in FIGS. 4, 5 and 10-12 in a user interface (UI). User devices 134a-n can include one or more software modules or applications to configure their respective processors 126a-n to collect and send respective functionality requests 132 via network 106 to either analytics server 102 or directly to database server 101. Such modules and applications can configure the processor 126 to send a functionality request 132 associated with selection of an output on a display device 121. For example, user device 134a hosts a browser 136 that can be used to select, in an interactive user interface (UI) an output to be analyzed. One example of an output is a specified website. User device 134a can include modules (not shown) for collecting and sending functionality requests 132 to analytics server 102 and/or database server 101. Although FIG. 1 depicts data warehouse 122 as being hosted locally on database server 101, in alternative embodiments, data warehouse 122 can be hosted on an external server (not shown) remote from system 100. For example, data warehouse 122 can be hosted on a remote database server accessible from system 100 via network 106.

Variables can be selected as output and corresponding functionality requests 132 can be initiated at a tablet user device 134b via interaction with browser 136 controls rendered on touch screen display device 121b and/or via a button input device 130b. Similarly, functionality requests 132 can be initiated at a smartphone user device 134b via interaction with browser 136 controls rendered on touch screen display device 121n and/or by using button input device 130n, or other user input received at a user device 134 via other input devices 130, such as, for example a keyboard, mouse, stylus, track pad, joystick, or remote control. The selection of a variable, such as, for example, an identifier for a website, is then sent with a functionality request 132 from the user device 134 via network 106. In embodiments, when a functionality request 132 for a selected variable (output) is received at analytics server 102, analytics tool 108 places a job corresponding to the request 132 on job queue 125 and then queries data warehouse 122 as jobs are de-queued from job queue 125. In this embodiment, the request 132 results in indications of identified KPIs for the selected variable being returned in results 135 from data warehouse 122 to the requesting user device 134. Results 135 can then be rendered in browser 136 to a requestor user associated with the requesting user device 134.

KPIs for a variable such as a website can be determined. The KPIs can reflect metrics gathered to measure effectiveness of advertisements (i.e., ads). Ads can have designated properties, such as keywords representing the desired context or online content in which the ad should appear. Advertisements can be interactive in that they can include a selectable hyperlink with a target URL that a viewer can click on while navigating through online content including the advertisement. For such interactive advertisements, the ad properties can include the target URL associated with a supplier of a product, brand, or service indicated in the interactive advertisement. For example, a viewer, using an input device 130, can interact with a browser 136 to click on an interactive advertisement in order to navigate to the target URL in a new browser tab, window or session. Metadata with properties (i.e., features) of advertisements can be extracted and stored in data warehouse 122. Users of system 100 can include users of a digital marketing suite, such as online content publishers, ad providers (i.e., advertisers), and viewers (i.e., end users of online content).

In an embodiment, user devices 134 comprise one or more content navigation devices, such as, but not limited to, an input device 130 configured to interact with browser-based UI of a browser 136, a touch screen display device 121, and an STB. Exemplary STB user device 134b can include, without limitation, an Internet Protocol (IP)-based (i.e., IPTV) STB. Embodiments are not limited to this exemplary STB user device 134b interfacing with network 106, and it would be apparent to those skilled in the art that other STBs and content navigation devices can be used in embodiments described herein as a user device 134, including, but not limited to, personal computers, mobile devices such as smart phones, laptops, tablet computing devices, or other devices suitable for rendering results 135 on display device 121. Many additional user devices 134a and tablet computing user devices 134b, and smartphone user devices 134n can be used with system 100, although only one of each such user device 134 is illustrated in FIG. 1. In an embodiment, a user device 134 may be integrated with a display device 121, so that the two form a single, integrated component. User devices 134a-n can include any suitable computing devices for communicating via network 106 and executing browser 136.

As shown in FIG. 1, each of the user devices 134a-n can be coupled to analytics server 102, and database server 101 through network 106. As shown in FIG. 1, analytics server 102 can be located separately from data warehouse 122. User devices 134 receive operational commands from users via input devices 130, including commands to initiate downloads of video content and commands to navigate to, select, and view websites and other online content via browser 136. A remote control (not shown) or other input device 130 may be used to control operation of STB user device 134. Some STBs may have controls thereon not requiring the use of a remote control.

Analytics server 102 may also be referred to as a “server” herein. Results 135 can include KPIs identified for interactive content viewed during a viewing session, wherein a viewing session is one or more of a video content viewing session or a video game session. In a video viewing session, network 106 may provide an asset corresponding to online content stored remotely at a web server. The asset can include one or more ads. In a video game session, a user can play video game at a user device 134 with ads inserted into the game.

According to an embodiment, system 100 displays reports showing results 135 in a user interface on display device 121. In embodiments, display device 121 may be one or more of a television, a network-enabled television, a monitor, the display of a tablet device, the display of a laptop, the display of a smart phone, or the display of a personal computer.

Analytics server 102 can receive functionality requests 132 from user devices 134a-n via network 106, wherein the functionality requests 132 correspond to respective selected variables. The variables can identify a website or other online content, such as, for example, video content as output. Results 135 distributed to user devices 134a-n identify KPIs for the selected variables. In embodiments, results 135 can also indicate the impact of each of a set of inputs on the output. According to additional embodiments, results 135 further indicate the partial independence of the output on any specific input. Results 135 and copies thereof may be resident in any suitable computer-readable medium, data warehouse 122, memory 124, and/or memories 128a-n. In one embodiment, the collected and queued functionality requests 132 can reside in memory 124 of analytics server 102. That is, job queue 125 can be resident in memory 124. In another embodiment, the functionality requests 132 and/or job queue 125 can be stored in a remote data store accessible from analytics server 102 via network 106. Similarly, results 135 can be accessed by user devices 134 from a remote location via database server 101 and/or be provided to user devices 134a-n via network 106.

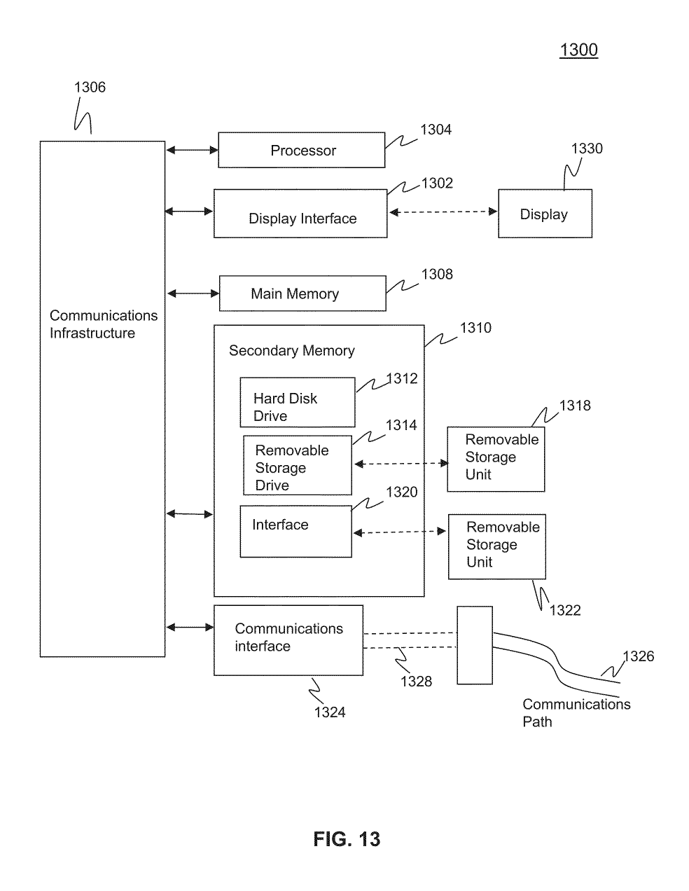

A cluster comprising database server 101 and analytics server 102 can include any suitable computing system for hosting data warehouse 122, cache 112, and analytics tool 108. As shown in FIG. 1, analytics server 102 includes a processor 123 coupled to a memory 124. According to certain embodiments, one or more of analytics server 102, database server 101, and user devices 134 may be embodied as separate, respective computing systems. In additional or alternative embodiments, one or more of analytics server 102 and database server 101 may be virtual servers implemented using multiple computing systems or servers connected in a grid or cloud computing topology. As described below with reference to FIG. 13, processor 123 may be a single processor in a multi-core/multiprocessor system. Such a system can be configured to operate alone with a single server, or in a cluster of computing devices operating in a cluster or server farm. Although not shown in FIG. 1 for the sake of simplicity, it is to be understood that analytics server 102 and database server 101 can each include one or more of their own respective processors and memories.

Network 106 may be a data communications network such as the Internet. In embodiments, network 106 can be one of or a combination of a cable network such as Hybrid Fiber Coax, Fiber To The Home, Data Over Cable Service Interface Specification (DOCSIS), Internet, Wide Area Network (WAN), WiFi, Local Area Network (LAN) or any other wired or wireless network. Analytics server 102 and database server 101 may produce results 135 identifying KPIs in response to functionality requests 132 related to a variety of online content including, but not limited to, websites, online video, web apps, and video games. System 100 can identify KPIs for electronic content, such as, for example, web objects (i.e., text assets, image assets, and scripts), downloadable objects (i.e., multimedia assets, software, and documents), and hosted applications (i.e., cloud-based software for games, e-commerce, and portals).

User devices 134a-n can establish respective network connections with database server 101 and analytics server 102 via network 106. Browser 136 can be executed at a user device 134 to establish a network connection via network 106. The network connection can be used to communicate packetized data representing functionality requests 132 and results 135 between user devices 134 and servers 101 and 102. User devices 134a-n can each provide respective functionality requests 132 to one or more of server 101 and 102 via network 106. Analytics server 102 can provide, via network 106, results 135 with identified KPIs in response to functionality requests 132 from user devices 134a-n. Browser 136 can access the streaming audiovisual content by retrieving one or more of functionality requests 132 via network 106. Network 106 can provide results 135 as packetized data. Browser 136 can configure the processor 126 to render a user interface presenting results 135 for display on display device 121.

In embodiments, browser 136 can be used to submit a functionality request 132 to identify one or more KPIs for a website identified by a Uniform Resource Locator (URL). In certain embodiments, the functionality request 132 can be additionally defined by metadata, such as, for example a video identifier retrieved from a content management system (CMS—not shown) accessible from a user device 134.

As shown in FIGS. 1 and 2, a user device 134 (i.e., a requestor or customer device) can initiate requests for desired functionality and send corresponding functionality requests 132 that database server 101 or analytics server 102 (i.e., the server side) can receive and process.

### Exemplary Method

FIG. 2 depicts an exemplary method for determining KPIs within the context of a digital marketing suite or digital marketing system. FIG. 2 is described with continued reference to FIG. 1. However, FIG. 2 is not limited to that exemplary embodiment.

FIG. 2 depicts a method 200 that can be carried out by components of system 100. FIG. 2 illustrates the method 200 from the initiation of a functionality request 132 to provision of corresponding results 135.

Method 200 begins in step 202 when a user initiates a request for desired functionality. As shown in FIG. 2, this step can be performed through sending a functionality request 132 to analytics tool 108. In an alternative embodiment, this step can comprise sending a functionality request 132 directly to data warehouse 122 for processing. After the functionality request 132 is initiated, control is passed to step 204 (or alternatively, directly step 210).

In step 204, an analytics tool receives the functionality request 132 initiated in step 202 and places it in job queue 125. As shown, step 204 can be performed by analytics tool 108 described above with reference to FIG. 1. In a non-limiting embodiment shown in FIG. 2, the analytics tool 108 carrying out step 204 can be embodied as Adobe® SiteCatalyst. After the functionality request 132 is placed in job queue 125, control is passed to step 210.

Next, in step 210, data warehouse request processing is performed. As shown, this step comprises querying data warehouse 122 for a copy of data needed to fulfill a received functionality request 132. The query generated in this step indicates a desired part of the data stored in data warehouse 122 based on a selected variable (i.e., an output such as a website) indicated in the received functionality request 132. This step can include retrieving data from cache 112 in cases where data warehouse 122 is missing some of the data needed to fulfill a functionality request 132. Examples of the types of data values and matrices retrieved in step 210 are described below with reference to FIGS. 3-5. In particular, details regarding the use of Singular Value Decomposition (SVD) to complete missing values in data matrices as a part of step 210 are discussed below with reference to FIGS. 4 and 5. As shown in FIG. 2, step 210 can be invoked by analytics tool 108 when step 204 is performed. According to this embodiment, when a job is taken from job queue 125, step 210 will receive a copy of data from data warehouse 122 needed to fulfill the functionality request 132 associated with the de-queued job. In an alternative embodiment, step 210 is performed after a functionality request 132 is submitted directly for data warehouse processing, thus bypassing step 204. After the data warehouse processing is completed, control is passed to step 216.

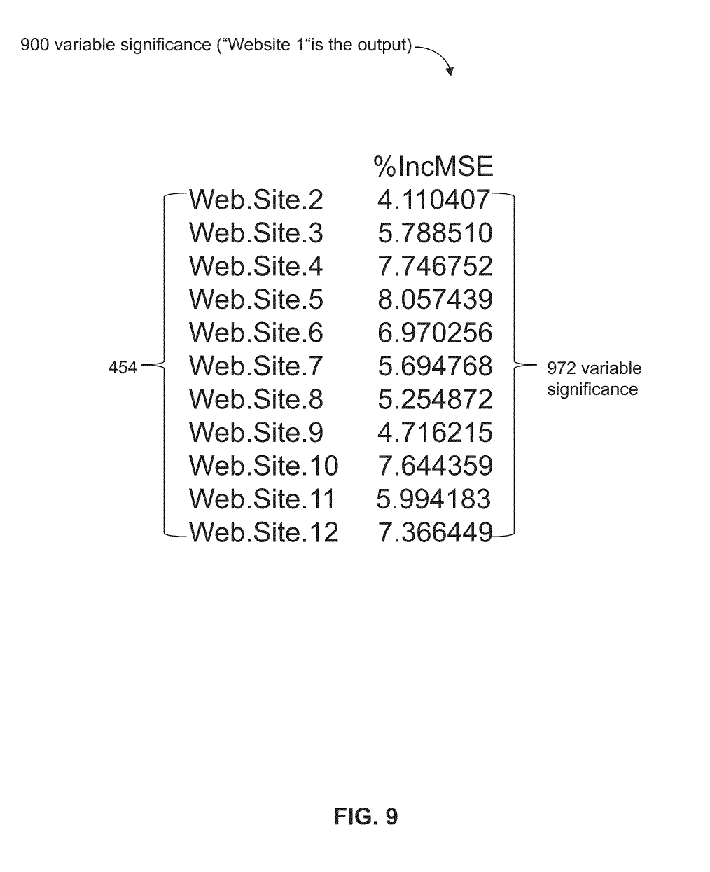

In step 216, the results 135 are sent to the requesting user and method 200 ends. Non-limiting examples of results 135 sent in this step are provided in FIGS. 9-12.

### Exemplary Data Matrices

FIGS. 3-5 illustrate exemplary data matrices defined and populated with sets of data values. The data sets and matrices depicted in FIGS. 3-5 are described with reference to the embodiments of FIGS. 1 and 2. However, the data sets are not limited to those example embodiments.

FIGS. 3A-3C depict exemplary data matrices for shopping data, textual data, and targeting data, respectively. In particular, FIG. 3A depicts a data matrix 300 of values related to online shopping, FIG. 3B depicts a matrix 330 of text data, and FIG. 3C depicts a matrix 340 with targeting data values. The matrices illustrated in FIGS. 3A-3C are defined as part of performing method 200. As described below, rows of the matrices can be defined to represent objects such as text documents, observations, website users/visitors, or website customers. Columns of the matrices can be defined to represent features, variables such as text strings, covariates, predictors, factors, regressors, inputs, or fields. In the matrices shown in FIGS. 3A-3C, columns can be features (i.e., attributes, or variables) associated with each user, visitor, or customer of a website.

With reference to FIG. 3A, shopping data matrix 300 is an n x d matrix with data values 326 for n customers 318 and d items 322. In the example provided in FIG. 3A, customers 318 are customers of a website and items 322 are items purchased on the website. That is, items 322 are items sold on an e-commerce website to customers 318. As shown, a particular value 326, denoted as Aᵢⱼ, represents a quantity of a particular item 324, denoted as item j, that was purchased by a particular customer 320, denoted as customer i. In the non-limiting example of FIG. 3A values 326 in shopping data matrix 300 represent monetary values of items 322 that have been purchased. These monetary values can be expressed in terms of a currency unit relevant to a requestor's electronic content. For example, values 326 can be expressed in terms of US dollars in cases where the requestor's websites conduct sales in US dollars. In additional or alternative embodiments, values 326 can represent a number of units of items 322 purchased by customers 318. As explained below with reference to FIGS. 4 and 5, exemplary methods and systems can complete partially and sparsely populated shopping data matrices 300 by filling in missing values 326.

With reference to FIG. 3A, shopping data matrix 300 is an n x d matrix with data values 326 for n customers 318 and d items 322. In the example provided in FIG. 3A, customers 318 are customers of a website and items 322 are items purchased on the website. That is, items 322 are items sold on an e-commerce website to customers 318. As shown, a particular value 326, denoted as Aᵢⱼ, represents a quantity of a particular item 324, denoted as item j, that was purchased by a particular customer 320, denoted as customer i. In the non-limiting example of FIG. 3A, values 326 in shopping matrix 300 represent monetary values of items 322 that have been purchased. These monetary values can be expressed in terms of a currency unit relevant to a requestor submitting a functionality request 132. For example, values 326 can be expressed in terms of US dollars in cases where the requestor's websites conduct sales in US dollars. In additional or alternative embodiments, values 326 can represent a number of units of items 322 purchased by customers 318. As explained below with reference to FIGS. 4 and 5, exemplary methods and systems can complete partially and sparsely populated shopping data matrices 300 by filling in missing values 326.

FIG. 3B depicts an m×d text data matrix 330 with data values 338 for m documents 328 and d terms 334. As shown in FIG. 3B, documents 328 are electronic documents comprising textual data and terms 334 are terms occurring in the documents 328. Terms 334 can be text strings found in documents on a website. In the example of FIG. 3B, a particular data value 338, denoted as Aᵢⱼ, represents the frequency with which a particular term 336, denoted as term j, occurs in a particular document 332, denoted as document i. According to the embodiment of FIG. 3B, values 338 represent a count of the number of times a term 334 appears in text documents 328. As discussed below with reference to FIGS. 4 and 5, exemplary methods and systems can complete partially- and sparsely-populated text data matrices 330 by filling in missing values 338.

With reference to FIG. 3C, targeting data matrix 340 depicts an m×d matrix with data values 350 for m users 342 and d advertisements (i.e., ads) 346. Users 342 can be visitors to a website and ads 346 can be ads displayed in the website. In the example of FIG. 3B, a particular data value 350 in matrix 340, denoted as Aᵢⱼ, represents a conversion associated with a particular ad 348, denoted as ad j and a particular user 344, denoted as user i. As shown, data values 350 can represent a monetary value associated with conversion of a given ad 346 by a given user 342. In this context, a conversion refers to the success of a specific ad 346, which can be a component of a website, in eliciting a response from a user 342 of the website. For example, in the context of a website, a web page component can be embodied as a selectable (i.e., clickable) ad 346. That is, the conversion data values 350 are a function of websites visited by users 344 and ads 346 that the users 344 interact with. In this example, a conversion data value 350 refers to monetization resulting from success of that ad 346 in eliciting a response from a user 344 to the website. When a website user 342 clicks, selects, or otherwise interacts with the ad 346, that interaction is deemed a conversion and a monetary value of the conversion is populated in the corresponding data value 350 within matrix 340. In alternative embodiments, data values 350 can represent a quantity of conversions (i.e., a number of selections or clicks on an ad 346) instead of a monetary value. As described in the following paragraphs, FIGS. 4 and 5 show how exemplary methods and systems can complete a partially- or sparsely-populated targeting data matrix 340 by filling in missing values 350.

FIG. 4 shows a partially-populated purchasing data matrix 400 with incomplete, null, or unknown purchasing data values 452 denoted as ‘NA.’ FIG. 4 shows customer purchasing data 452 on different websites 454. As shown, matrix 400 includes known and unknown (i.e., missing) purchasing data values 452 for a plurality of websites 454. Completion or filling in of these unknown values results in the matrix shown in FIG. 5. Such completion can be performed as part of step 210 shown in FIG. 2. In embodiments, completion of the matrix 400 to produce matrix 500 can be accomplished by carrying out targeting, collaborative filtering, and/or matrix completion techniques. In accordance with embodiments, various algorithms can be used to complete the unknown values 452. In certain embodiments, completion of the unknown values 452 is performed using an iterative version of Singular Value Decomposition (SVD). As will be appreciated by persons skilled in the relevant art(s), SVD is a factorization of a real or complex matrix, such as, for example, a high-dimensional matrix of partial customer purchasing data. As is case with matrix 400, data for a set of websites 454 is often incomplete, in the sense that many values 452 (i.e., matrix entries) are missing. In an embodiment, method 200 uses a regularized singular value decomposition (RSVD) algorithm to compute the missing values in an incomplete matrix, such as matrix 400, in order to produce a completed matrix, such as matrix 500. FIG. 5 shows a completed matrix 500 resulting from applying an RSVD algorithm to replace the missing purchasing data entries 452 with completed purchasing data entries 552. In a non-limiting embodiment, an SVD algorithm is used to produce matrix 500, where SVD is defined as X=UD V^{t}, where X is an m×n matrix. According to this embodiment, X can be decomposed into U, the left singular vectors, where U is an m×n orthogonal matrix, UU^{t}=U^{t}U=i and V, the right singular vectors, where V is an n×n orthogonal matrix, VV^{t}=V^{t}V=1 and D =diag (d₁,d₂, . . . , dₙ) with the singular vectors d₁≧d₂≧ . . . ≧dₙ≧0. An SVD exists for any matrix and is unique up to signs (i.e., positive or negative values). For a centered matrix X, step 210 can comprise the sub steps of: (1) computing the

$${min}_{\begin{matrix}⏟ \\ {U}_{q} , {V}_{q} , {D}_{q}\end{matrix}} ∥ X - {U}_{q} {D}_{q} {V}_{q} ∥$$

in order to obtain a numerical rank of the matrix, q. After performing the computation of sub step (1), the q-rank of the matrix can be computed in sub step (2) as X_{q}=U_{q}D_{q}V_{q} using the newly computed X_{q} value to produce new values 552 in matrix 500 for the missing, ‘NA’ entries 452 shown in matrix 400. At this point, step 210 can iterate sub steps (1) and (2) until there is convergence by using ∥X_{q}(i+1)−X_{q}(i)I/IX_{q}(i)∥≦δ for a small δ.

In certain embodiments, for any data matrix, a user can select one of the columns of the matrix as an output (i.e., a website 454) as part of initiating a functionality request 132. In response to the functionality request 132, the system 100 can show, for the website 454 selected to be the output, what the significant input variables (i.e., predictors) amongst the rest of the columns are. In the example of FIGS. 4 and 5, results 135 can indicate KPIs for the selected website 454 and partial dependencies of that website 454 on any specified variable, where the variables include purchasing data values 452. For example, a requestor user can select a website 454 column from completed matrix 500 as output when the user wants to see what the impact of variables are for sales data values 452 for the selected website 454. The results 135 will indicate variables that impact the selected website 454 as well as indicating the variables' effect on the rest of the websites 454 (i.e., the other columns of matrix 500). That is, for a selected website 454 column in matrix 500, a result 135 will indicate how complete purchasing data 552 for this website 454 is dependent on any other website 454 in matrix 500. According to an embodiment, a functionality request 132 can be initiated when a user selects two websites 454, which are columns in matrix 500, and the corresponding results 135 will show the user how these two columns are dependent on one another.

### Exemplary KPI Analysis Using a Random Forest of Decision Trees

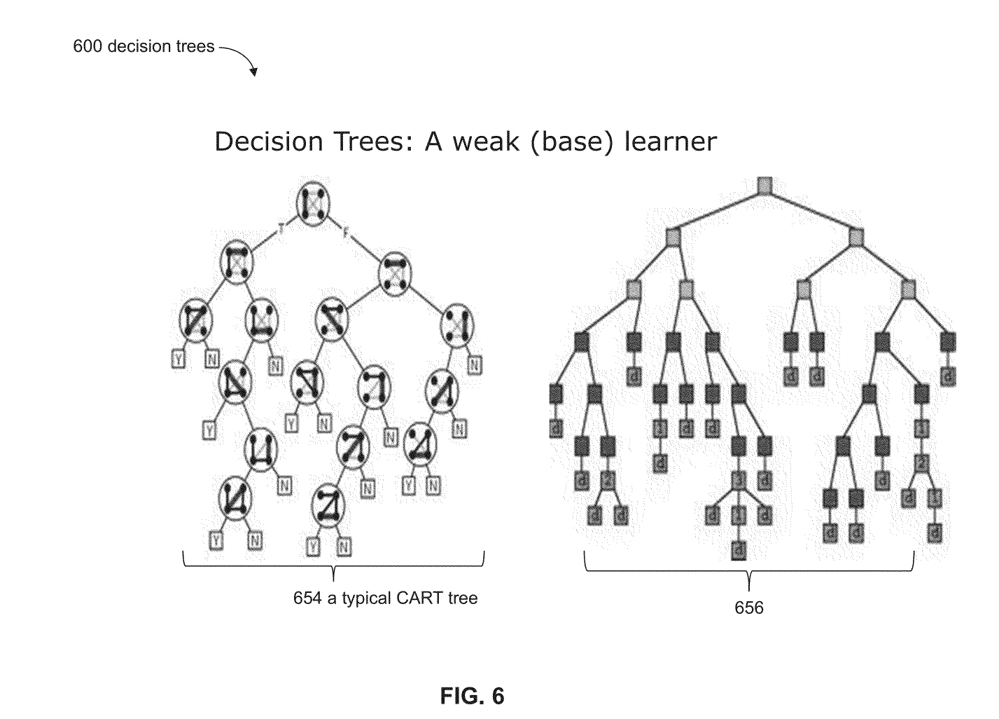

FIGS. 6-8 illustrate how KPI analysis can be performed using a random forest of decision trees, according to embodiments of the present disclosure. FIG. 6 illustrates decision trees 654 and 656, where trees 654 and 656 each represent a Classification and Regression Tree (CART). Tree 654 can be used as a base learner. For example, by evaluating binary choices in internal (non-leaf) nodes of tree 654, yes or no decisions can be reached. These decisions are denoted as Y and N leaf nodes in tree 654. Tree 654 can be used to reach the decision, leaf nodes shown in tree 656, which are denoted as d leaves.

FIG. 7 depicts an example random forest 700 of decision trees 760a-n. An embodiment uses a plurality of CART trees such as trees 760a-n in an ensemble technique. Random forest 700 can comprise, for example, a plurality of CART trees. Random forest 700 is a classifier that uses a number of decision trees in order to improve a classification rate. Random forest 700 represents an ensemble learning technique for classification and regression that operates by constructing a multitude of decision trees 760a-n at training time and then outputting the class that is the mode of the classes output by individual decision trees 760a, 760b, . . . 760n. In the embodiment shown in FIG. 7, many CART trees 760a-n are used in random forest 700. In certain embodiments, thousands, hundreds, or tens of thousands of decision trees 760 (i.e., trees in the order of 10⁴) can be included in random forest 700, with each decision tree 760 acting independent of the others. As shown in FIG. 7, each tree 760 will arrive at its own respective decision 762 based on evaluating a common input 758. FIG. 7 depicts how the individual decisions 762 can be collectively considered in a voting step 764 to arrive at an overall decision 766. In an embodiment, decisions 762 can be binary yes or no votes. For example, if decision trees 760 are used to decide whether or not to approve a line of credit or a loan for a customer, tree 760a may arrive at a yes decision 762a, tree 760b may arrive at a no decision, and out of thousands of other trees 760, the majority ‘vote’ of trees 760 in random forest 700 would be determined in step 764 to determine the overall decision 766. In this example, overall decision 766 is the outcome of random forest 700. In an example embodiment, if, out of ten thousand decision trees 760, six thousand trees 760 arrive at negative/no decisions 762, and four thousand arrive at positive/yes decisions 762, the overall decision 766 would be no. In this way, each tree 760 in random forest 700 is independent from other trees 760, which enables random forest 700 to arrive at a very accurate overall decision 766. Here, the accuracy of random forest 700 is a function of the independence of trees 760 and the number of trees 760 in forest 700. An original overall decision 766 of random forest 700 is determined for a data matrix when all of the columns of the matrix have completed values in their original formation. Forest 700 can be iteratively used with changed matrix values to arrive at another overall decision 766, which is another output produced by forest 700 so that one can see how this output differs from the original overall decision 766.

FIG. 8 illustrates an example random forest 800 of decision trees 860a-n with weighted averages. As shown, a decision trees 860a-n can be used to produce respective decisions 868a-n based on evaluating a common input 858. These individual, independent decisions 868 can then be used to arrive at an overall decision 870. In embodiments, overall decision 870 can be based at least in part on one or more of a weighted majority of decisions 868, a weighted average of decisions 868, and/or applying a weighted average of estimated probabilities rule to decisions 868.

Random forests 700 and 800 can be used to initially produce an overall result (i.e., overall result 766) based on all variables having their original values. Then, by changing values for variables, embodiments determine much of an impact a given variable has on a selected output. By using random forests such as forests 700 and 800, changes in an output (i.e., metrics values for a selected website) can be identified. The more changes in output that are seen, the more impact a variable has had. As explained in the following paragraph, the random forests shown in FIGS. 7 and 8 can show how the impact of any given variable is determined, where the variable is selected from a matrix.

By using forests 700 and/or 800, results 135 can be generated to show the impact of a selected, specific variable. With reference to the example of FIG. 5, the variable selected as output can be a specific website 454. According to this example, there are twelve variables, that is, variables associated with twelve websites 454. If a user selected one website 454, e.g., ‘website 1’ as the output when initiating a functionality request 132, there will be eleven variables (i.e., eleven other websites 454) left. By using forest 700, embodiments can determine, for example, the impact of changing values for variable number two. At this point, the other ten variables are fixed. For variable number two (e.g., ‘website 2’ in FIG. 5), an embodiment randomly changes the values of entries 552 in matrix 500 and permutes the changed values in matrix 500. Column number two can have, for example twenty-two rows of values 552. An embodiment moves these rows arbitrarily using uniform random variation. For example, this embodiment shuffles the values 552 of column two so as to arrive at a permutation. By examining the overall result 766, forest 700 can determine if this variable has no significant impact on the output. That is, forest 700 can be used to determine if changes in data values 552 would not result in a significant increase in a mean squared error (MSE) for a selected variable. The more significant a variable is, the more its preservation (i.e., fixing values) would change the selected output. Then, this permutation is performed for each one of the rest of the variables (i.e., the other websites 454 besides website 1 and website 2). When the subsequent permutations are performed, an embodiment fixes all the other variables except one, and a forest is used to determine its impact on the output. The higher the impact of a variable's preservation is, the more significant the variable is. In this way, forests 700 and 800 can be used to find the significance of each single variable on a given matrix, such as, for example matrix 500. By fixing all of the columns except one, an embodiment can isolate the impact of that variable or input column on a selected output column (i.e., website 1). An example report showing variable significance in terms of relative percentage increases in MSE for websites 454 is provided in FIG. 9, which is discussed below. Using a test data set, such as, for example, matrix 500, an embodiment can compute a misfit error, expressed in terms of relative MSE, for each decision tree. According to this embodiment, the average misfit for each variable (with and without permutation) is then normalized. The higher the misfit (i.e., the higher an MSE), the higher significance an input variable has.

### Exemplary Reports

FIGS. 9-12 illustrate exemplary reports, plots, and graphs according to embodiments of the present disclosure. The reports, plots, and graphs depicted in FIGS. 9-12 are described with reference to the embodiments of FIGS. 1-8. However, the reports, plots, and graphs are not limited to those example embodiments.

In embodiments, a display device 121 can be used to display the reports shown in FIGS. 9-12 as part of a user interface (UI). For example, the reports shown in FIGS. 9-12 may be displayed via the display interface 1302 and the computer display 1330 described below with reference to FIG. 13. In certain embodiments, the UIs can be configured to be displayed on a touch screen display device 121. In an embodiment, a user interface (UI) for analytics tool 108 can depict the reports illustrated in FIGS. 9-12. The reports can be displayed on user devices 134a-n on respective ones of display devices 121a-n.

FIG. 9 provides an example report 900 showing variable significance for a set of websites 454. In particular, report 900 indicates, for each of a plurality of websites 454, their relative variable significance 972. In the example of FIG. 9, variable significance for websites 454 is expressed in terms of respective percentage increases in MSE where website 1 is the selected output. As shown, report 900 is a sorted list showing a percentage increase in MSE corresponding to permutations/changes of data values for each website, other than website 1, in a set of websites 454. In the example of FIG. 9, the higher the MSE percentage is for a given input variable, the more significant the input variable is. That is, more significant variables have higher variable significance 972 values.

Although report 900 is sorted by variable name (i.e., website identifiers or names), it is to be understood that report 900 can be sorted by variable significance 972 as well. For example, in an embodiment where report 900 is presented in an interactive UI on a display device 121, in response to input received via an input device 130, columns of report 900 can be sorted. For example, variable significance 972 can be selected and sorted in ascending or descending order.

FIG. 10 provides an exemplary plot 1000 graphically depicting the variable significance 972 for the set of websites 454 listed in report 900. As shown in FIG. 10, ‘website 5,’ which exhibited the highest percentage increase in MSE, is the most significant variable. That is, changes in data values for website 5 resulted in greater changes than permutations of data values for websites 2-12. In the example of FIG. 10, website 1 is the user-selected output, and plot 1000 depicts relative variable significance 972 for other websites 454 besides website 1.

FIGS. 11 and 12 illustrate exemplary graphs showing partial dependence of a selected output on specified variables. In particular, FIG. 11 depicts a graph 1100 showing partial dependence of a selected output (i.e., website 1) on a specific variable (i.e., website 7). In both FIGS. 11 and 12, the selected output is website 1. As discussed above with reference to FIG. 2, the output can be selected when a functionality request 132 is initiated. FIG. 11 shows how permutations of conversion values 1172 for website 7 affect conversion values 1154 for website 1. In the non-limiting examples shown in FIGS. 11 and 12 units shown for conversion values 1154, 1172, 1254, and 1272 are currency amounts (i.e., dollars) associated with conversions for websites. The dependencies depicted in FIGS. 11 and 12 can be computed using regression analysis, thus there is extrapolation on the data to show dependency of a dependent variable on an independent variable. This can be performed for each of the websites 454 shown in FIG. 10 to determine relative dependencies of each dependent variable on an independent variable (i.e., a variable associated with website 1).

As shown in FIG. 11, the output, website 1, is partially dependent on the input variable, website 7. FIG. 12 provides an exemplary graph 1200 showing partial dependence of the selected output (i.e., website 1) on another variable (i.e., website 5). Consistent with the results shown in FIGS. 9 and 10, graph 1200 shows how conversion values 1254 for website 1 are significantly affected by permutations of conversion values 1272 for website 5. By reviewing the plots and graphs of FIGS. 10-12, a user can readily determine that the selected output, website 1, is more dependent on the website 5 variable than other variables.

According to embodiments, users such as publishers of online content, distributors of online content, advertisers, marketing analysts, and/or a network administrators can interact with the reports, plots and graphs shown in FIGS. 9-12 using input devices such as, but not limited to, a stylus, a finger, a mouse, a keyboard, a keypad, a joy stick, a voice activated control system, or other input devices used to provide interaction between a user and a UI displaying the reports, plots and graphs. Such interaction can be used to select an output, such as a website, and to indicate a variable to be analyzed, such as another website. The interaction can also be used to select other outputs and variables corresponding to selected audience segments, user device types, distribution channels, or advertising campaigns to be analyzed. The interaction can be also be used to navigate through multiple results 135, and to select one or more KPIs identified in results 135 to be further analyzed.

The exemplary reports, plots and graphs depicted in FIGS. 9-12 enable users to efficiently identify success metrics for online advertising. The reports can be included as part of a dashboard summarizing aggregated metrics and variable dependencies across multiple websites 454. According to this embodiment, the summary dashboard can display or list metrics such as total viewers (i.e., viewership), total ad impressions, and total ad revenue for websites 454 visited using browsers 136 of user devices 134. In additional or alternative embodiments, results 135 can be expressed in terms of user-selected audience segments (i.e., demographic groups of website visitors and customers) and/or on certain platforms. Platforms of interest can be indicated by selecting types of user devices 134 (i.e., desktop computers, tablet devices 134b, smartphone devices 134n) and/or certain versions of browsers 136. For example, by selecting segments (e.g., males having bachelor's degrees) and a platform (e.g., a tablet), a user can filter the analytics data presented in the dashboard to a subset of interest.

In embodiments, the reports plotting variable significance and dependence of output on variables presented in FIGS. 9-12 is made available to analytics tools and systems, such as, for example, analytics tool 108, Adobe® SiteCatalyst, and Adobe® Analytics. According to these embodiments, historical analysis can be performed within an integrated data platform including both real-time and historical data that is seamlessly available to network operations staff and marketing/analyst teams.

### Exemplary Computer System Implementation

Although exemplary embodiments have been described in terms of systems and methods, it is contemplated that certain functionality described herein may be implemented in software on microprocessors, such as a processors 126a-n and 128 included in the user devices 134a-n and analytics server 102, respectively, shown in FIG. 1, and computing devices such as the computer system 1300 illustrated in FIG. 13. In various embodiments, one or more of the functions of the various components may be implemented in software that controls a computing device, such as computer system 1300, which is described below with reference to FIG. 13.

Aspects of the present invention shown in FIGS. 1-12, or any part(s) or function(s) thereof, may be implemented using hardware, software modules, firmware, tangible computer readable media having logic or instructions stored thereon, or a combination thereof and may be implemented in one or more computer systems or other processing systems.

FIG. 13 illustrates an example computer system 1300 in which embodiments of the present invention, or portions thereof, may be implemented as computer-readable instructions or code. For example, some functionality performed by user devices 134a-n and servers 101 and 102 shown in FIG. 1, can be implemented in the computer system 1300 using hardware, software, firmware, non-transitory computer readable media having instructions stored thereon, or a combination thereof and may be implemented in one or more computer systems or other processing systems. Hardware, software, or any combination of such may embody certain modules and components used to implement steps in the method 200 illustrated by the flowchart of FIG. 2 discussed above and the reports discussed above with reference to FIGS. 9-12.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 1300. After reading this description, it will become apparent to a person skilled in the relevant art how to implement the embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1304 may be a special purpose or a general-purpose processor device. As will be appreciated by persons skilled in the relevant art, processor device 1304 may also be a single processor in a multi-core/multiprocessor system, such system operating alone, or in a cluster of computing devices operating in a cluster or server farm. Processor device 1304 is connected to a communication infrastructure 1306, for example, a bus, message queue, network, or multi-core message-passing scheme. In certain embodiments, one or more of the processors 123 and 126a-n described above with reference to system 100, database server 101, analytics server 102, and user devices 134a-n of FIG. 1 can be embodied as the processor device 1304 shown in FIG. 13.

Computer system 1300 also includes a main memory 1308, for example, random access memory (RAM), and may also include a secondary memory 1310. Secondary memory 1310 may include, for example, a hard disk drive 1312, removable storage drive 1314. Removable storage drive 1314 may comprise a magnetic tape drive, an optical disk drive, a flash memory, or the like. In non-limiting embodiments, one or more of the memories 124 and 128a-n described above with reference to analytics server 102 and user devices 134a-n of FIG. 1 can be embodied as the main memory 1308 shown in FIG. 13.

The removable storage drive 1314 reads from and/or writes to a removable storage unit 1318 in a well-known manner. Removable storage unit 1318 may comprise a magnetic tape, optical disk, etc. which is read by and written to by removable storage drive 1314. As will be appreciated by persons skilled in the relevant art, removable storage unit 1318 includes a non-transitory computer readable storage medium having stored therein computer software and/or data.

In alternative implementations, secondary memory 1310 may include other similar means for allowing computer programs or other instructions to be loaded into computer system 1300. Such means may include, for example, a removable storage unit 1322 and an interface 1320. Examples of such means may include a program cartridge and cartridge interface (such as that found in video game devices), a removable memory chip (such as an EPROM, or PROM) and associated socket, and other removable storage units 1322 and interfaces 1320 which allow software and data to be transferred from the removable storage unit 1322 to computer system 1300. In non-limiting embodiments, one or more of the memories 124 and 128a-n described above with reference to analytics server 102 and user devices 134a-n of FIG. 1 can be embodied as the main memory 1308 shown in FIG. 13.

Computer system 1300 may also include a communications interface 1324. Communications interface 1324 allows software and data to be transferred between computer system 1300 and external devices. Communications interface 1324 may include a modem, a network interface (such as an Ethernet card), a communications port, a PCMCIA slot and card, or the like. Software and data 1328 transferred via communications interface 1324 may be in the form of signals, which may be electronic, electromagnetic, optical, or other signals capable of being received by communications interface 1324. These signals may be provided to communications interface 1324 via a communications path 1326. Communications path 1326 carries signals and may be implemented using wire or cable, fiber optics, a phone line, a cellular phone link, an RF link or other communications channels.

As used herein, the terms “computer readable medium” and “non-transitory computer readable medium” are used to generally refer to media such as memories, such as main memory 1308 and secondary memory 1310, which can be memory semiconductors (e.g., DRAMs, etc.). Computer readable medium and non-transitory computer readable medium can also refer to removable storage unit 1318, removable storage unit 1322, and a hard disk installed in hard disk drive 1312. Signals carried over communications path 1326 can also embody the logic described herein. These computer program products are means for providing software to computer system 1300. A computer-readable medium may comprise, but is not limited to, an electronic, optical, magnetic, or other storage device capable of providing a processor with computer-readable instructions. Other examples comprise, but are not limited to, a floppy disk, a CD-ROM, a DVD, a magnetic disk, a memory chip, ROM, RAM, an ASIC, a configured processor, optical storage, magnetic tape or other magnetic storage, or any other medium from which a processor such as processors 123 and processors 126a-n shown in FIG. 1, or processor device 1304 can read instructions. The instructions may comprise processor-specific instructions generated by a compiler and/or an interpreter from code written in any suitable computer-programming language. Non-limiting examples of a suitable programming language can include C, C++, C#, Visual Basic, Java, Python, Perl, JavaScript, and ActionScript.

Computer programs (also called computer control logic) are stored in main memory 1308 and/or secondary memory 1310. Computer programs may also be received via communications interface 1324. Such computer programs, when executed, enable computer system 1300 to implement the present invention as discussed herein. In particular, the computer programs, when executed, enable processor device 1304 to implement the processes of the present invention, such as the steps in the method 200 illustrated by the flowchart of FIG. 2 discussed above. Accordingly, such computer programs represent controllers of the computer system 1300. Where an embodiment of the invention is implemented using software, the software may be stored in a computer program product and loaded into computer system 1300 using removable storage drive 1314, interface 1320, and hard disk drive 1312, or communications interface 1324.

In an embodiment, the display devices 121a-n used to display interfaces of browser 136 or and interface of analytics tool 108 may be a computer display 1330 shown in FIG. 13. The computer display 1330 of computer system 1300 can be implemented as a touch sensitive display (i.e., a touch screen). Similarly, the reports shown in FIGS. 9-12 may be embodied as a display interface 1302 shown in FIG. 13.

Embodiments of the invention also may be directed to computer program products comprising software stored on any computer readable medium. Such software, when executed in one or more data processing device, causes a data processing device(s) to operate as described herein. Embodiments employ any computer readable medium. Examples of computer useable mediums include, but are not limited to, primary storage devices (e.g., any type of random access memory), secondary storage devices (e.g., hard drives, floppy disks, CD ROMS, DVDs, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### General Considerations

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing device memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing device from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the steps presented in the examples above can be varied—for example, steps can be re-ordered, combined, and/or broken into sub-steps. Certain steps or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A computer-implemented method comprising:
receiving, at a computing device, a request to determine a significance of an input variable to an output variable, wherein the input variable is a website characteristic and the output variable is a website-interaction metric;
retrieving a data set comprising information about website characteristics of existing websites and historical information about actual interactions with the existing websites, wherein the data set comprises entries for the input variable and entries for the output variable for one or more websites;
replacing missing entries in the data set with implied values; and
determining, by the computing device, the significance of the input variable to the output variable.

2. The method of claim 1 further comprising:
assessing a relative significance of each of a plurality of input variables to the output variable; and
identifying one or more of the plurality of input variables as Key Performance Indicators (KPIs) based at least in part on the relative significance of one or more of the plurality input variables to the output variable.

3. The method of claim 1, further comprising producing a response to the request, the response indicating the significance of the input variable to the output variable.

4. The method of claim 1, further comprising:
identifying a partial dependence of the output variable on each of a plurality of input variables; and
producing a response to the request, the response indicating the partial dependence of the output variable on each of the plurality of input variables.

5. The method of claim 1, wherein the replacing comprises:
populating a matrix with the entries from the retrieved data set; and
iteratively performing a Singular Value Decomposition (SVD) of the matrix to compute the missing entries.

6. The method of claim 1, wherein the replacing comprises:
populating a matrix with the entries from the retrieved data set; and
iteratively performing a regularized singular value decomposition (RSVD) of the matrix to compute the missing entries.

7. The method of claim 1 wherein the determining comprises:
determining, using a plurality of decision trees and the entries in the data set, an original decision; and
for each input variable in a plurality of input variables:
determining, using the plurality of decision trees and permutations of the entries in the data set, another decision;
comparing the original decision to the another decision; and
determining a relative significance of the respective input variable to the output variable based on a difference between the original decision and the another decision.

8. The method of claim 7, wherein the plurality of decision trees comprises a random forest of Classification and Regression Trees (CART).

9. The method of claim 1, wherein determining the significance of the input variable to the output variable comprises:
determining an average misfit error for the input variable; and
using the average misfit error to determine the significance of the input variable to the output variable.

10. The method of claim 9 wherein the average misfit error for the input variable is determined by:
using test data and training data to compute misfit error values for the input variable;
averaging the misfit error values to determine an average misfit error value;
normalizing the average misfit error value; and
using the normalized misfit error value to determine the significance of the input variable to the output variable.

11. The method of claim 1, wherein:
the output variable is a website-interaction metric associated with components of one of the existing websites; and
the input variable corresponds to another existing website other than the one of the existing websites.

12. The method of claim 1, wherein:
the existing websites comprise at least one advertisement;
the output variable is a conversion metric associated with the at least one advertisement; and
the computing device hosts an analytics tool.

13. A system comprising:
a server comprising a processor and a memory having executable instructions stored thereon, that, if executed by the processor, cause the server to perform operations comprising:
receiving a request to determine a significance of an input variable to an output variable, wherein the input variable is a website characteristic and the output variable is a website-interaction metric;
retrieving a data set comprising information about website characteristics of existing websites and historical information about actual interactions with the existing websites, wherein the data set comprises entries for the input variable and entries for the output variable for one or more websites;
replacing missing entries in the data set with implied values; and
determining the significance of the input variable to the output variable.

14. The system of claim 13, wherein the operations further comprise:
assessing a relative significance of each of a plurality of input variables to the output variable;
identifying a partial dependence of the output variable on each of the plurality of input variables; and
producing a response to the request, the response indicating one or more of:
the relative significance of each of the plurality of input variables to the output variable; and
the partial dependence of the output variable on each of the plurality of input variables.

15. The system of claim 14, the server further comprising a display device, wherein the operations further comprise:
storing the response in the memory; and
presenting, in an interactive user interface on a display device, data representing the response.

16. The system of claim 13, the server further comprising an input device and a display device, wherein the operations further comprise, prior to the receiving:
displaying, in user interface on the display device, a plurality of variables; and
in response to receiving, in the user interface, via the input device, a selection of one the plurality of variables as the output variable, initiating the request.

17. A non-transitory computer readable storage medium having executable instructions stored thereon, that, if executed by a computing device, cause the computing device to perform operations for determining Key Performance Indicators (KPIs) associated with website content, the instructions comprising:
instructions for receiving a request to determine a significance of an input variable to an output variable, wherein the input variable is a website characteristic and the output variable is a website-interaction metric;
instructions for retrieving a data set comprising information about website characteristics of existing websites and historical information about actual interactions with the existing websites, wherein the data set comprises entries for the input variable and entries for the output variable for one or more websites;
instructions for replacing missing entries in the data set with implied values; and
instructions for determining the significance of the input variable to the output variable.

18. The computer readable storage medium of claim 17, wherein the instructions for replacing comprise:
instructions for populating a matrix with the entries from the retrieved data set; and
instructions for iteratively performing a Singular Value Decomposition (SVD) of the matrix to compute the missing entries.

19. The computer readable storage medium of claim 17, wherein the instructions for replacing comprise:
instructions for populating a matrix with the entries from the retrieved data set; and
instructions for iteratively performing a regularized singular value decomposition (RSVD) of the matrix to compute the missing entries.

20. The computer readable storage medium of claim 17, wherein the instructions for determining comprise:
instructions for determining, using a plurality of decision trees and the entries in the data set, an original decision; and
for each input variable in a set of input variables:
instructions for determining, using the plurality of decision trees and permutations of the entries in the data set, another decision;
instructions for comparing the original decision to the another decision; and
instructions for determining a relative significance of the respective input variable to the output variable based on a difference between the original decision and the another decision.
